(19) United States
(12) Patent Application Publication
(10) Pub. No.: US 2003/0059103 A1
(43) Pub. Date: Mar. 27, 2003

(54) Surface inspection of object using image processing

(75) Inventors: Junichi Shiomi, Kamikyo-ku (JP); Atsushi Imamura, Kamikyo-ku (JP); Hiroshi Sano, Kamikyo-ku (JP); Haruo Uemura, Kamikyo-ku (JP); Takao Kanai, Kamikyo-ku (JP); Hiroki Fujimoto, Kamikyo-ku (JP); Masahiko Kokubo, Kamikyo-ku (JP); Masahiro Horie, Kamikyo-ku (JP)

Correspondence Address: McDERMOTT, WILL & EMERY, 600 13th Street, N.W., Washington, DC, 20005-3096, US

(73) Assignee: DAINIPPON SCREEN MFG. CO., LTD.

(21) Appl. No.: 10/251,787

(22) Filed: Sep. 23, 2002

(30) Foreign Application Priority Data
Sep. 26, 2001 (JP) 2001-294313(P)
Oct. 25, 2001 (JP) 2001-328190(P)
Jul. 26, 2002 (JP) 2002-217666(P)

(51) Int. Cl. G06K 9/00

(52) U.S. Cl. 382/144

(57) ABSTRACT

White light is irradiated onto the surface of a printed circuit board from an oblique direction to capture a color information image MG0. Infrared light is also irradiated from a substantially perpendicular direction to capture an infrared light image IRM. Region segmentation is performed based on the color information image MG0 produces an image MG3 representing an integrated color region which includes a gold region GL and a brown region BR. Using this image MG3 and the infrared light image IRM, the gold region GL can be distinguished from the brown region BR. In another embodiment, a plurality of images relating to a plurality of wavelength bands of light are respectively captured for an inspection region. Then, an image characteristic value is calculated for the plurality of images, and a wavelength band R7 which is appropriate for an inspection is selected on the basis of this image characteristic value. At the time of inspection, images of each object are successively obtained in relation to light in the selected wavelength band R7, whereupon an inspection of each object is executed on the basis of these images.

### BACKGROUND OF THE INVENTION

1. Field of the Invention

This invention relates to technology for performing a surface inspection of an object using image processing.

2. Description of the Related Art

Printed circuit boards for electronic circuits have conductive patterns such as circuit wiring or contact pads, and silk characters printed on an insulator substrate. In an inspection of a printed circuit board, the printing quality of the conductive patterns and silk characters is inspected. Conventionally, inspections have mainly been conducted visually.

In recent years, packaging methods in which electronic components such as semiconductor chips are mounted directly onto a conductive pattern on a substrate have come to be used. If a defect is present in the contact pads or wiring pattern that are in direct contact with the electronic components, product defects are likely to occur, and hence requests for inspections of the conductive pattern are increasing. Meanwhile, due to demand in recent years for large scale integration, the surface area for and spacing of the contact pads is growing smaller, as a result of which visual inspections are becoming more and more difficult. In addition, there has been a trend toward a reduction in the numbers of skilled inspectors. Consequently, technology enabling surface inspections of printed circuit boards to be performed without the need for skilled inspectors has been strongly desired. These desires are not limited to surface inspections of printed circuit boards, but extend to general surface inspections of any object.

Inspection methods for printed circuit boards using an inspection apparatus, for example that described in JP-A-9-21760, are known. In this method, images of a printed circuit board are obtained using an infrared cut filter and a blue filter respectively, whereupon defects in the soldered portion are detected on the basis of these images.

However, using an infrared cut filter and blue filter is appropriate for inspections of the soldered portion of a printed circuit board, but it is considered preferable to use light in a different wavelength band for inspections of the other parts of the printed circuit board. Furthermore, when the object of the inspection is not a printed circuit board, the appropriate wavelength band of the light used for the inspection largely depends on the material of the object of the inspection. Therefore, technology which, when an arbitrary object is to be inspected, enables the easy determination of an appropriate wavelength band for capturing images of the object of the inspection has been desired in the prior art.

Accordingly, a first object of the present invention is to provide technology which enables surface inspections of objects without the need for skilled inspectors.

A second object of the present invention is to provide technology which enables the easy determination of an appropriate wavelength band for capturing images of an object upon the inspection of an arbitrary object for inspection.

### SUMMARY OF THE INVENTION

In order to achieve at least part of the above objects, there is provided a method and device for inspecting the surface condition of an object. The inspection apparatus comprises: an illumination optical system comprising a first light source for irradiating the surface of an object for inspection from an oblique direction with first light, and a second light source for irradiating the surface of the object from a substantially perpendicular direction with second light whose principal spectrum range is in longer wavelengths than the first light; an imaging device for capturing a first image including image components relating to at least two color components included in the first light and for capturing a second image relating to the second light; and a region identifying section for identifying a specific color region having a specific color on the surface of the object on the basis of the first image and second image.

The reason why the first light is irradiated onto the surface from an oblique direction is that if light is irradiated onto the surface from a substantially perpendicular direction, it is difficult to obtain surface color information. More specifically, if light is irradiated onto the surface from a substantially perpendicular direction, regular reflection (mirror reflection) may occur such that surface color information cannot be obtained. If the first light is irradiated onto the surface from an oblique direction, on the other hand, a first image representing the surface colors can be obtained. Furthermore, when the second light is irradiated onto the surface from a substantially perpendicular direction, a second image which reflects the differences in the regular reflectance of each region on the surface can be obtained. Since a region of a specific color is identified on the basis of the first image and second image obtained in this manner, the specific color region of the object for inspection can be recognized by means of image processing, the use of which enables a surface inspection to be performed with ease.

The region identifying section may comprise the functions of: identifying an integrated color region which includes the specific color region and another color region having a color which is close to that of the specific color region; and identifying the specific color region from the integrated color region using a tone value of the second image relating to the second light. In this case, it is preferable for the spectrum of the second light to be set such that the contrast between the specific color region and the other color region is larger in the second image than in the first image.

According to this arrangement, the specific color region can be identified from the integrated color region using the contrast in the second image. As a result, the specific color region can be easily distinguished from another color region which has a color close to the specific color even when separation of the two regions is difficult by means of image processing only on the first image.

It is preferable that when the object for inspection is a printed circuit board for an electronic circuit and the specific color region is a gold-plated region, the second light be infrared light.

According to this arrangement, a gold-plated region on a printed circuit board can be easily identified.

The imaging device may also comprise a first imaging device for capturing the first image and a second imaging device for capturing the second image at the same time as the image capturing is performed by the first imaging device. In this case, the first light may be white light and the second light may be infrared light.

According to this arrangement, inspection can be performed in a comparatively short time, thereby enhancing the throughput of the inspection.

Alternatively, the imaging device may execute the capturing of the first image and the capturing of the second image using the same imaging element at different points in time.

According to this arrangement, the number of components of the imaging device can be reduced.

It is preferable for the second light to be converged light which converges into a small light spot on the surface of the object for inspection.

According to this arrangement, the light quantity per unit area on the surface may be increased. Furthermore, even when the surface is uneven and irregular, the proportion of light which is scattered by these irregularities is reduced, and thus excessive deterioration in the quantity of light reaching the imaging element can be prevented.

Alternatively, the imaging device may comprise: an image forming optical system which is housed inside a lens barrel; a first imaging device for capturing the first image by receiving the first light which has passed through the image forming optical system; and a second imaging device for capturing the second image by receiving the second light which has passed through the image forming optical system at the same time as the image capturing is performed by the first imaging device, wherein the first light is visible light and the second light is infrared light, the principal wavelength band of which does not overlap that of the visible light, and wherein the visible light and infrared light reflected by the object for inspection pass in common through at least one lens in the image forming optical system housed inside the lens barrel to be respectively formed into images by the first and second imaging devices.

In this arrangement, the visible light and infrared light use the lens housed inside the same lens barrel in common, and hence a small number of components is sufficient, whereby the optical system is simplified. Also, since the main wavelength bands of the visible light and infrared light do not overlap, there is no interference therebetween, and hence two images can be captured simultaneously.

The infrared light may be converged light which converges into a small light spot on the surface of the object for inspection, and the convergent angle of the infrared light may be set to be larger than the convergent angle of the visible light.

Since the infrared light is irradiated onto the object for inspection from a substantially perpendicular direction, the quantity of reflected light may vary greatly if unevenness or irregularities are present on the object for inspection. By enlarging the convergent angle of the infrared light in such a case, the effect of irregularities on the object for inspection on the quantity of reflected light can be reduced.

The illumination optical system may comprise a plate-type dichroic mirror for separating the light reflected off the surface into the first light and second light.

A plate-type dichroic mirror has a superior light-separating characteristic to a prism-type dichroic mirror (a so-called dichroic prism), and can therefore separate the first and second lights more efficiently.

The imaging device may comprise a first imaging element for capturing the first image and a second imaging element for capturing the second image, and the first and second imaging elements may have identical characteristics.

According to this arrangement, an advantage is gained in that the attachment mechanism of the imaging elements and method of adjustment thereof can be normalized.

The present invention is also directed a method and apparatus for inspecting in succession a plurality of objects of the same kind. The inspection apparatus comprises: an imaging device capable of capturing a plurality of images of an inspection region on each object where the plurality of images are associated with a plurality of wavelength bands of light, respectively; a wavelength band selector for selecting, on the basis of the plurality of images of at least one object from among the plurality of objects, a wavelength band which is suitable for inspection from among the plurality of wavelength bands; and an inspection executing section for executing an inspection of each object for inspection on the basis of the image of each object captured by the imaging device associated with the light in the selected wavelength band.

According to this inspection apparatus, a appropriate wavelength band for inspection is selected on the basis of the plurality of images which are captured in relation to a plurality of wavelength bands of light, respectively, whereupon an inspection is executed using light in this wavelength band. As a result, when an inspection is to be performed on an arbitrary object for inspection, a wavelength band which is suitable for capturing an image of the object for inspection can be determined with ease.

The wavelength band selector may calculate a value of a predetermined image characteristic for the plurality of images, and to execute selection of the wavelength band on the basis of this image characteristic value.

According to this arrangement, an appropriate wavelength band can be selected automatically in accordance with the image characteristic value.

It is preferable for the image characteristic value to be a relative value between an inspection point and a non-inspection point specified in advance in the inspection region. For example, the contrast between the inspection point and non-inspection point may be used as this image characteristic value.

It should be noted that the present invention may be realized in various ways. For example, the present invention may be realized as a surface inspection method and device for an object, a method and device for recognizing or extracting a region of a subject surface, a method and device for selecting a wavelength band, a computer program for implementing the functions of these methods or devices, a computer readable medium for storing this computer program, or a data signal embodied in a carrier wave including the computer program.

These and other objects, features, embodiments, and advantages of the present invention will become clearer from the description of the preferred embodiments and the drawings.

### BRIEF DESCRIPTION OF THE DRAWINGS

FIG. 1 is a block diagram showing the structure of an inspection apparatus according to a first embodiment of the present invention.

FIG. 2 is a graph showing spectra of white light and infrared light.

FIG. 3 is a flowchart showing an inspection processing sequence according to the first embodiment.

FIG. 4 shows a color information image of a printed circuit board PCB.

FIG. 5 shows the processing of steps T2 to T6.

FIG. 6 is a graph showing the spectral reflectance characteristics of a gold region GL (gold-plated region) and a brown region BR (base region).

FIG. 7 is a block diagram showing the structure of an inspection apparatus of a second embodiment.

FIG. 8 is a graph showing the spectral transmittance characteristics of a cube-type dichroic mirror and a plate-type dichroic mirror.

FIGS. 9(a) and 9(b) are explanatory views showing variations of the structure of an infrared light source 420 in a third embodiment.

FIG. 10 is a flowchart showing an inspection processing sequence in a fourth embodiment.

FIG. 11 is a block diagram showing the structure of an inspection apparatus of a fifth embodiment.

FIG. 12 is a block diagram showing the structure of an inspection apparatus of a sixth embodiment.

FIG. 13 shows the structure of a host processor 100.

FIG. 14 is a flowchart showing a region segmentation procedure in an embodiment.

FIG. 15 shows the setting of representative colors.

FIG. 16 is a flowchart showing in detail the procedure of step S4 in FIG. 14.

FIGS. 17(A) and 17(B) show a method of color normalization.

FIG. 18 shows the distribution of individual colors classified into 4 types of representative color clusters.

FIG. 19 shows a plurality of divided regions.

FIG. 20 is a block diagram showing the structure of an inspection apparatus according to a seventh embodiment of the present invention.

FIG. 21 is a graph showing the spectral transmittance of a plurality of color filters of a color filter plate 40.

FIG. 22 is a flowchart showing the inspection processing sequence in the seventh embodiment.

FIG. 23 is a flowchart showing in detail the procedure of step T4.

FIG. 24 is a graph showing the spectral reflectance characteristics of a gold region and a brown region.

### DESCRIPTION OF THE PREFERRED EMBODIMENTS

Embodiments of the present invention will now be described in the following sequence.

A. First Embodiment

B. Second Embodiment

C. Third Embodiment

D. Fourth Embodiment

E. Fifth Embodiment

F. Sixth Embodiment

G. Details of Region Segmentation Processing

H. Seventh Embodiment

I. Modifications

A. First Embodiment

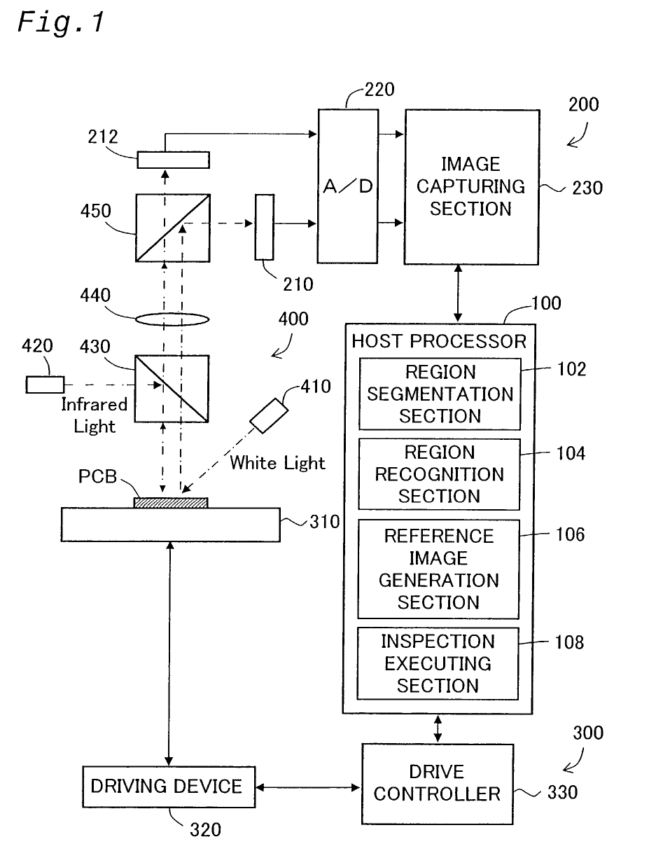

FIG. 1 is a block diagram showing the structure of an inspection apparatus of a first embodiment of the present invention. This inspection apparatus is a device for inspecting a printed circuit board PCB for an electronic circuit and comprises a host processor 100, an imaging device 200, a driving mechanism 300 and an illumination optical system 400.

The host processor 100 has a function of performing control of the operations of the entire inspection apparatus, and also has the functions of a region segmentation section 102, a region recognition section 104, a reference image generation section 106, and an inspection executing section 108. These functions are implemented by computer programs which are stored on a computer readable medium (not shown) of the host processor 100. The content of these functions will be described later.

The imaging device 200 comprises two CCD elements 210, 212, an A/D converter 220, and an image capturing section 230. A first CCD element 210 is used when capturing a color multiple tone image while the surface of a printed circuit board PCB is illuminated with white light. A second CCD element 212 is used when capturing an infrared light-related multiple tone image while the surface of the printed circuit board PCB is illuminated with infrared light.

The driving mechanism 300 comprises an X-Y stage 310 on which the printed circuit board PCB is placed, a driving device 320 for driving the X-Y stage 310, and a drive controller 330 for controlling the driving device 320. This driving mechanism 300 is used to position the printed circuit board PCB in a desired position with respect to the illumination optical system 400.

The illumination optical system 400 comprises a white light source 410, an infrared light source 420, a half prism 430, a lens system 440, and a dichroic prism 450. In this embodiment, a halogen lamp equipped with an infrared cut filter is used as the white light source 410, and an infrared LED which emits near-infrared light is used as the infrared light source 420.

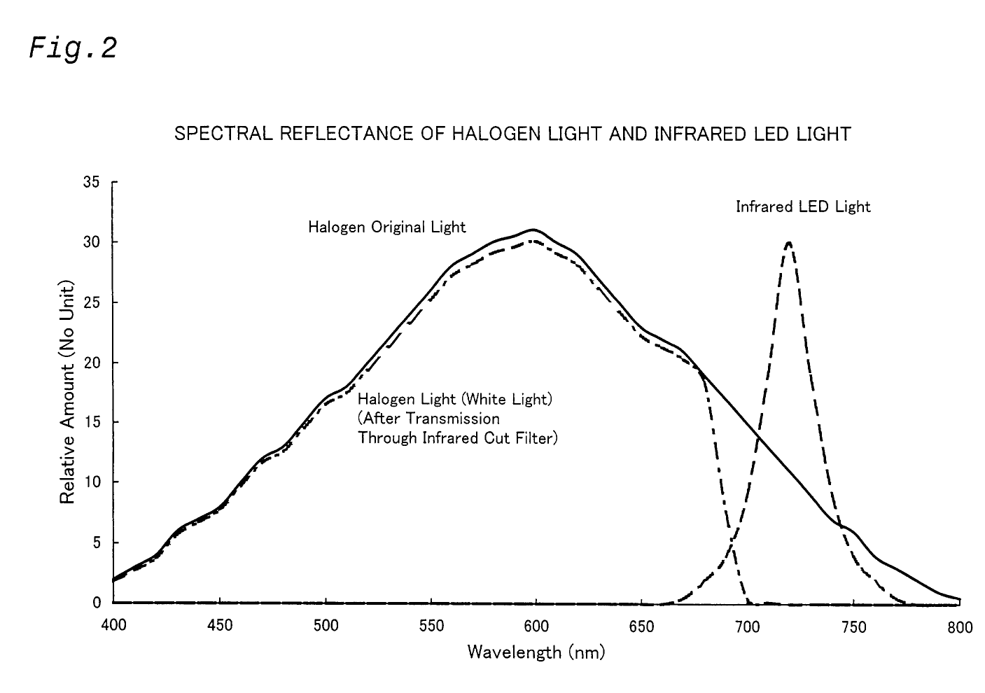

FIG. 2 is a graph showing the spectra of the white light and infrared light. The solid line is a spectrum of halogen light emitted from the halogen lamp, and the dashed line is a spectrum of halogen light after transmission through the infrared cut filter. The broken line is a spectrum of infrared light emitted from the infrared LED. As can be understood from the drawing, the white light and infrared light used in this embodiment are adjusted such that the principal wavelength bands in their respective spectra do not substantially overlap. Here, “principal wavelength bands” means wavelength ranges having a strength of 20% or more of the peak strength value.

The white light source 410 irradiates white light onto the surface of the printed circuit board PCB from an oblique direction. When white light is irradiated onto the surface of the printed circuit board PCB from an oblique direction, reflected light in a normal direction to the surface has wavelengths corresponding to the colors of each pixel on the surface. Accordingly, when this reflected light is captured by the CCD element 210, a color image containing color information about the surface of the printed circuit board PCB is obtained.

The reflected light which is reflected in the normal direction from the surface of the printed circuit board PCB passes through the half prism 430 and the lens system 440 and is reflected by the dichroic prism 450 to enter the CCD element 210. This CCD element 210 is a color CCD capable of generating output signals for the RGB color components. The three color component signals from the CCD element 210 are respectively converted into digital data by the A/D converter 220. These digital data are received by the image capturing section 230 and stored inside the image capturing section 230 as color image data.

The infrared light which is emitted from the infrared light source 420 is reflected by the half prism 430 to become incident on the surface of the printed circuit board PCB substantially perpendicularly. Here, “substantially perpendicularly” indicates a range of 90±5 degrees. The infrared light is regularly reflected, or specularly reflected, by the surface of the printed circuit board PCB and then passes through the half prism 430, lens system 440, and dichroic prism 450 to enter the second CCD element 212. The output signal of the CCD element 212 is converted into digital data by the A/D converter 220 and received by the image capturing section 230 as multiple tone image data for infrared light.

The second CCD element 212 may be a monochrome CCD, or alternatively an identical element to the first CCD element 210 may be used. If identical elements are used as the two CCD elements 210, 212, an advantage is gained in that the attachment mechanisms and adjustment methods thereof may be normalized.

A color multiple tone image which is obtained using white light or visible light will be referred to as a “color information image”, and a monochrome multiple tone image which is obtained using infrared light will be referred to as an “infrared light image”.

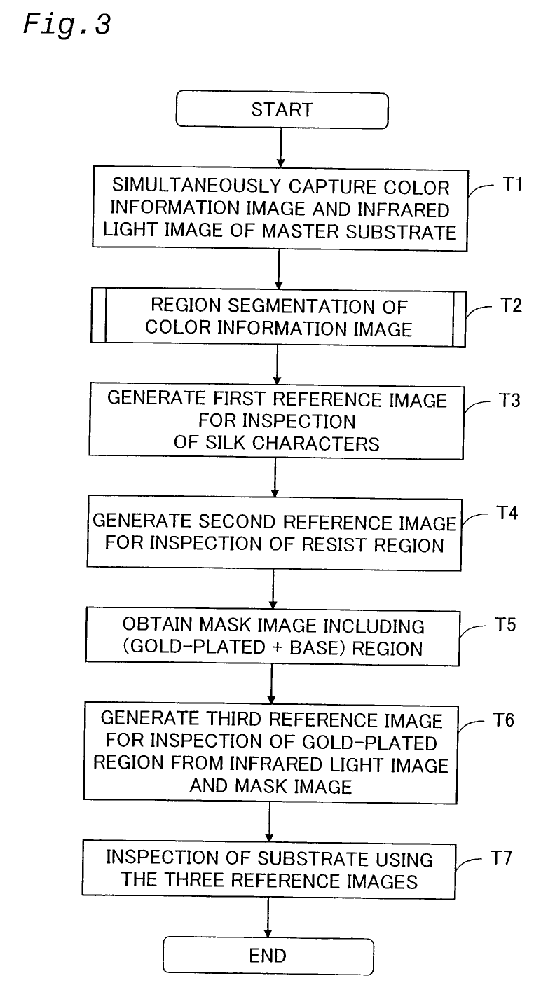

FIG. 3 is a flowchart showing the inspection processing sequence of the first embodiment. In step T1, a master substrate (also referred to as a “reference substrate”) is prepared, and a color information image and infrared light image of the master substrate are captured simultaneously using the inspection apparatus of FIG. 1. Here, “master substrate” indicates a standard printed circuit board PCB which is used for capturing various reference images to be used in a surface inspection of the printed circuit board PCB. A substrate with almost no defects and on which conductive patterns and silk characters are printed substantially according to plan is used as the master substrate.

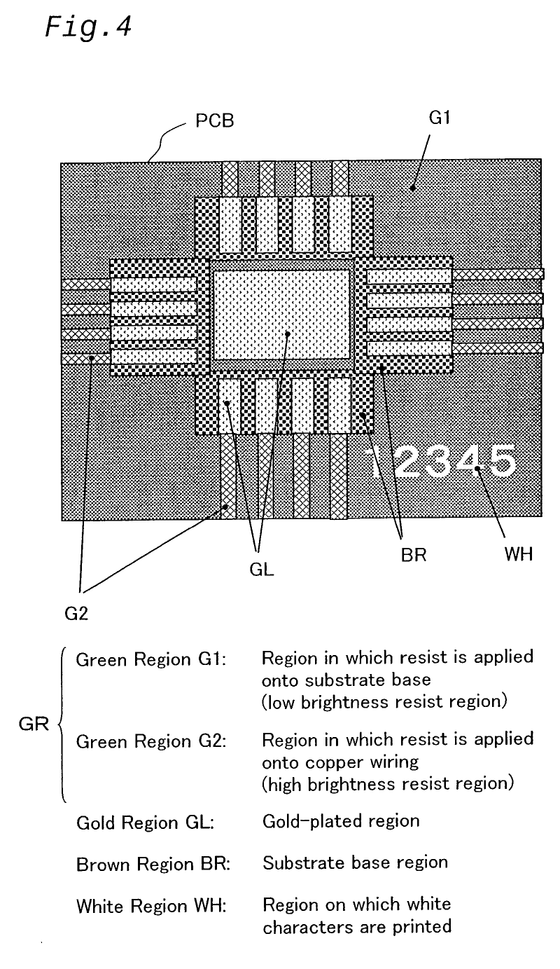

FIG. 4 shows a color information image of the printed circuit board PCB. The surface of the printed circuit board PCB includes a first green region G1 in which resist is applied onto the substrate base, a second green region G2 in which resist is applied onto copper wiring, a gold region GL in which gold plating is applied, a brown region BR of the substrate base, and a white region WH in which white silk characters are printed on the substrate base. The substrate base below the first green region G1 is brown, and the copper wiring below the second green region G2 is copper-colored, and therefore the colors of these two green regions G1 and G2 are slightly different, although both remain green in color. Consequently, these two green regions G1 and G2 are also referred to in this embodiment as a combined “green region GR”. In the processing to be described below, the two green regions G1, G2 are dealt with as one green region GR (or resist region).

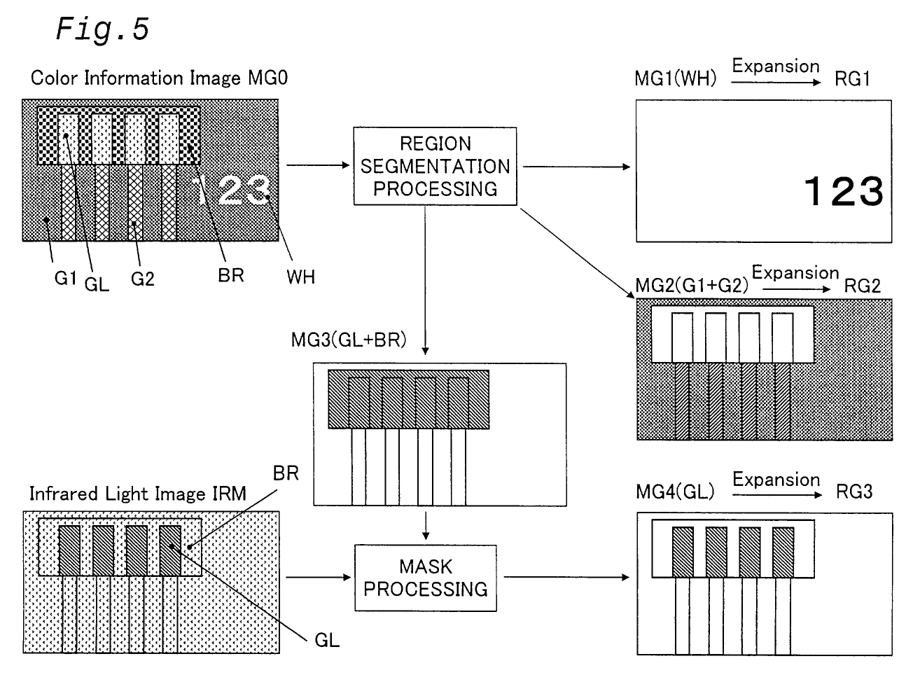

In step T2 of FIG. 3, the region segmentation section 102 (FIG. 1) executes region segmentation of the color information image. FIG. 5 shows the processing content of steps T2 to T6. As is illustrated here, region segmentation of the color information image MG0 produces three images: a white region image MG1 reprensenting the white region WH, a green region image MG2 representing the resist region GR (G1+G2), and a gold/brown region image MG3 representing an integrated region (integrated color region) of the gold region GL and the brown region BR. These three color region images MG1 to MG3 may be binary images or multi tone images. If the color region images MG1 to MG3 are binary images, then the following processing becomes easier. This region segmentation processing will be described later in detail.

In region segmentation processing, the gold region GL (gold plated region) and brown region BR (base region) are not separated but extracted as an integrated region. The reason for this is that these two regions GL and BR are close in color. In other words, the gold region GL has considerable variations in image density, and may appear brown in parts depending on the way in which light strikes. Consequently, in the region segmentation of the color information image MG0, it may be impossible to separate these two regions successfully. Hence, in the region segmentation using the color information image MG0, an integrated region including the gold and brown regions is extracted, and as will be explained later, the gold region GL and the brown region BR are separated using the infrared light image.

In step T3 of FIG. 3, the reference image generation section 106 generates a first reference image RG1 for inspecting silk characters from the white region image MG1. This first reference image RG1 is an image in which the white regions inside the white region image MG1 are expanded by a predetermined width. The expansion processing is aimed at making a tolerance in the position and size of the silk characters. In step T4, a second reference image RG2 for inspecting the resist region is created in a similar manner to step T3, by means of the reference image generation section 106 performing expansion processing on the green region image MG2.

In step T5, the region recognition section 104 receives the gold/brown region image MG3 as a mask image, and in step T6 the infrared light image IRM is subjected to mask processing using this mask image MG3. This mask processing produces a gold region image MG4 representing the gold region GL. Specifically, a region corresponding to the brown/gold region (GL+BR) of the mask image MG3 is extracted from within the infrared light image IRM, and the regions of the extracted image which have a higher brightness value than a predetermined threshold are recognized as the gold region GL.

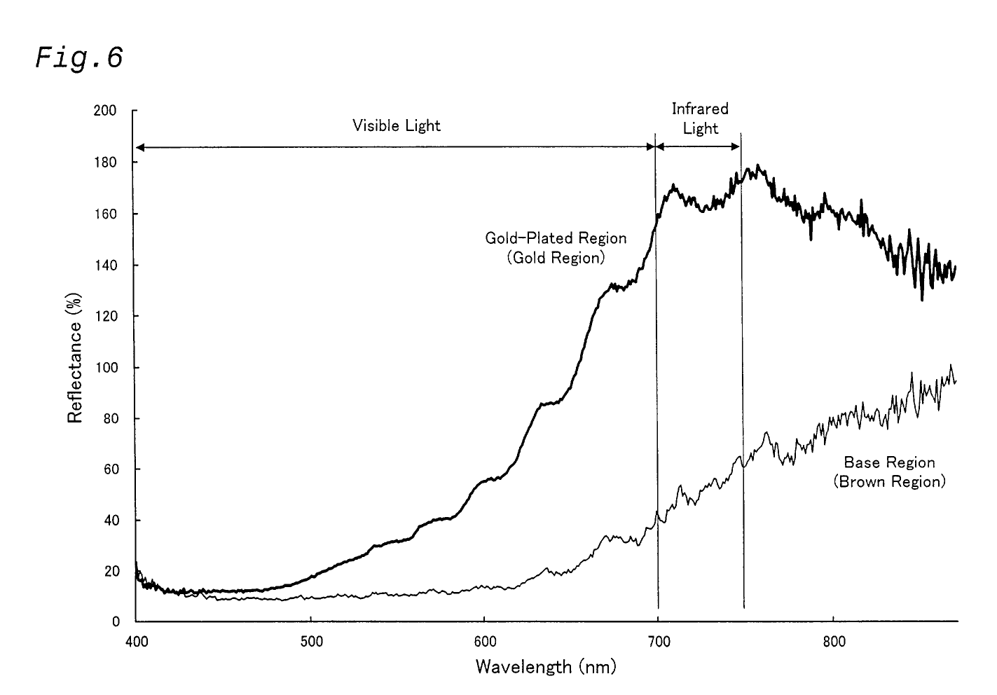

The reason why the gold region GL is separated from the brown region BR by means of this mask processing is as follows. FIG. 6 is a graph showing the spectral reflectance characteristics of the gold region GL (gold plated region) and the brown region BR (base region). The contrast between the two regions is generally proportional to the reflectance ratios thereof. Accordingly, the contrast between the gold region GL and the brown region BR is comparatively small in the visible light region, but comparatively large in the infrared light region. The visible light region in FIG. 6 corresponds to the wavelength band of the white light emitted from the white light source 410, as shown in FIG. 2, and the infrared light region in FIG. 6 corresponds to the wavelength band of the infrared light emitted from the infrared light source 420. In the infrared light image IRM (FIG. 5), the contrast between the gold region GL and the brown region BR is large, and hence it is possible to identify the gold region GL alone from the gold/brown region extracted from the color information image MG0.

The reference image generation section 106 (FIG. 1) generates a third reference image RG3 (FIG. 5) for inspecting the gold-plated region by performing expansion processing on the image MG4 (FIG. 5) which representes the gold region GL recognized in the aforementioned manner. Thus the preparation of the first reference image RG1 for inspecting the silk characters, the second reference image RG2 for inspecting the resist region, and the third reference image RG3 for inspecting the gold-plated region is completed.

In step T7 in FIG. 3, inspection of the substrate, or the inspection object, is executed using these three reference images RG1 to RG3. Specifically, the printed circuit board PCB is placed as the inspection object on the X-Y stage 310 of the inspection apparatus illustrated in FIG. 1, whereupon the color information image MG0 and the infrared light image IRM are captured. Then, the inspection executing section 108 (FIG. 1) executes prescribed image processing using these images MG0 and IRM, for the inspection object and the three reference images RG1 to RG3 obtained for the master substrate. In this inspection, for example, a judgment is made as to whether or not the silk character region, resist region and gold-plated region are within their respective permissible ranges.

Items to be inspected may include: defects in the shape of the silk characters, defects in the shape of the resist, and defects and irregularities (unevenness) in the gold-plated region. If there are irregularities in the gold-plated section, large variation will occur in the tone values of the elevated and recessed portions of the gold-plated region in the infrared light image IRM. Thus, if the gold region GL of the inspection object is extracted using the infrared light image IRM, it is possible to detect irregularities in the gold-plated region.

In the first embodiment described above, the gold region GL is identified from the gold/brown region which is extracted by the region segmentation of the color information image MG0 using the contrast in the infrared light image IRM, and it is therefore possible to identify with ease and a high level of precision the gold region GL and the brown region BR, which are difficult to identify in the color information image MG0. Furthermore, the color information image MG0 and the infrared light image IRM can be captured simultaneously using the dichroic prism 450 and the two CCD elements 210, 212. As a result, inspection time can be shortened and the throughput of the inspection can be enhanced.

B. Second Embodiment

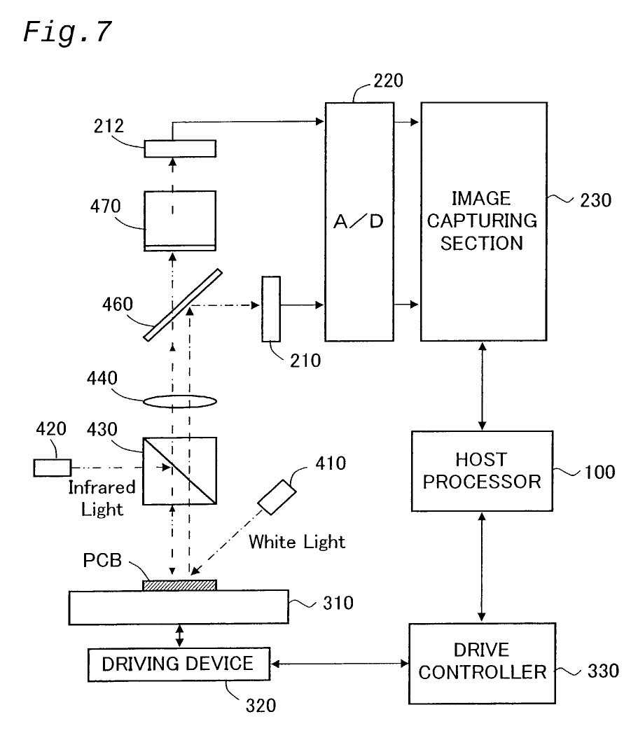

FIG. 7 is a block diagram showing the structure of an inspection apparatus of the second embodiment. This inspection apparatus has a structure in which the dichroic prism 450 of the first embodiment shown in FIG. 1 is replaced with a dichroic mirror 460, and a corrective glass flat plate 470 is added to the image side of the dichroic mirror 460. In all other aspects of the apparatus are the same as the first embodiment.

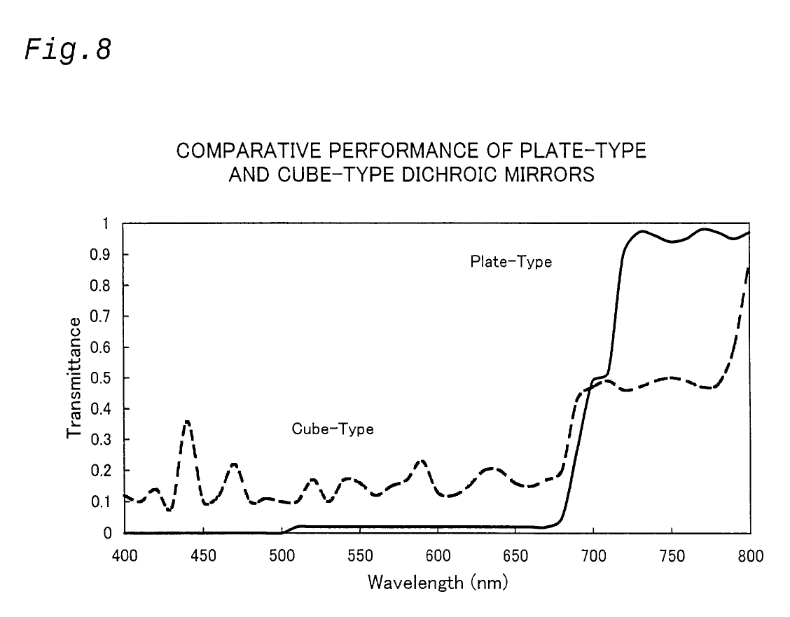

The reason for replacing the dichroic prism 450 with the dichroic mirror 460 is that the dichroic mirror 460 has a superior characteristic for separating white light and infrared light. FIG. 8 is a graph showing the transmittance characteristics of the dichroic prism 450 (cube-type dichroic mirror) and the dicroic mirror 460 (plate-type dichroic mirror). The two types of dichroic mirror of FIG. 8 are both designed to reflect light of wavelengths of less than 700 nm and to transmit light of wavelengths of 700 nm or greater. The plate-type is superior to the cube-type in its characteristic of separating light according to wavelength, and it is therefore preferable that a plate-type dichroic mirror be used.

Plate-type dichroic mirrors, however, tend to generate astigmatism. The corrective glass flat plate 470 is provided in order to correct this astigmatism. The corrective glass flat plate 470 has a similar planar form to the dichroic mirror 460, and is in a rotated position around the vertical optical path by 90 degrees from that of the dichroic mirror 460. The reason the corrective glass flat plate appears in block form in FIG. 7 is that the flat plate slanted as described above is seen from the front in the figure.

C. Third Embodiment

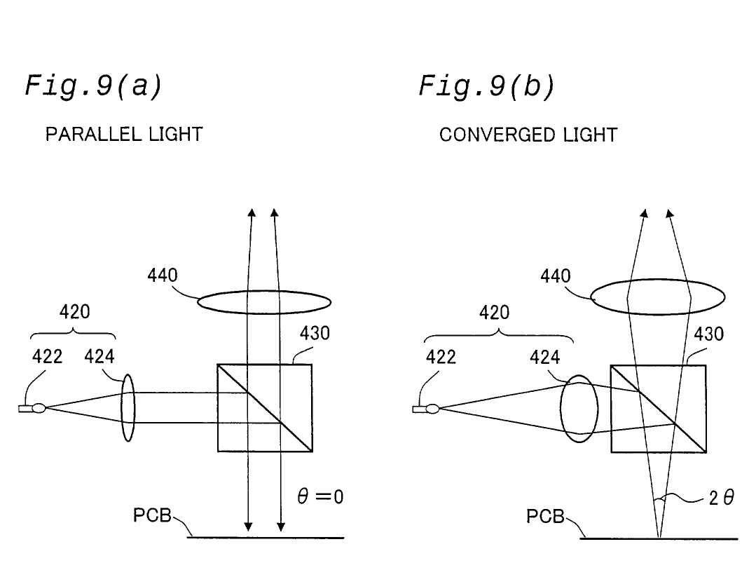

FIGS. 9(a) and 9(b) show two types of the structure of the infrared light source 420 in a third embodiment. The infrared light source 420 includes a near-infrared LED 422 and a convex lens 424. In the structure in FIG. 9(a), the light emitted from the infrared light source 420 is substantially parallel light, and the surface of the printed circuit board PCB is irradiated by this parallel light. On the other hand, in the structure in FIG. 9(b), the light emitted from the infrared light source 420 is converged light which converges into a small light spot on the surface of the printed circuit board PCB. Note that apart from that of the infrared light source 420, the same structure as the aforementioned first or second embodiment may be employed as the structure of the inspection apparatus.

If the surface of the printed circuit board PCB is irradiated with converged light which converges into a comparatively small light spot, it is possible to increase the quantity of light per unit area. Further, even when there are irregularities or unevenness on the surface of the printed circuit board PCB, the quantity of reflected light reaching the CCD element 212 can be increased. The reason for this is that when the surface of the printed circuit board PCB is irradiated with parallel light, light is widely scattered due to the irregularities on the surface, and thereby the quantity of light reaching the CCD element 212 is reduced.

In the case of the converged light as shown in FIG. 9(b), when considering the outermost light rays of the pencil of rays thereof, the angle formed by these light rays may be defined as 2θ (referred to hereinbelow as “convergent angle 2θ”). Also, the numerical aperture NA of this pencil of rays may be defined as NA=sin θ. In the parallel light shown in FIG. 9(a), the convergent angle 2θ of the pencil of rays thereof is zero. As can be understood from this explanation, the convergent angle 2θ of the pencil of rays may also be defined for non-convergent light.

If the convergent angle 2θ of the light (for example infrared light) that is irradiated substantially perpendicularly onto the printed circuit board PCB is made larger, the effect on the quantity of inspection light of irregularities on the surface of the printed circuit board PCB can be reduced, as described above. As concerns light (for example visible light of white light) which is irradiated in an oblique direction, on the other hand, the effect on the quantity of inspection light of irregularities on the surface of the printed circuit board PCB is small even when the convergent angle 2θ is small. Accordingly, it is generally preferable that the convergent angle 2θ of light irradiated onto the printed circuit board PCB in a perpendicular direction be made larger than the convergent angle 2θ of light irradiated in an oblique direction. This type of characteristic is applicable to the aforementioned first and second embodiments, and may also be applied to other embodiments to be described below.

D. Fourth Embodiment

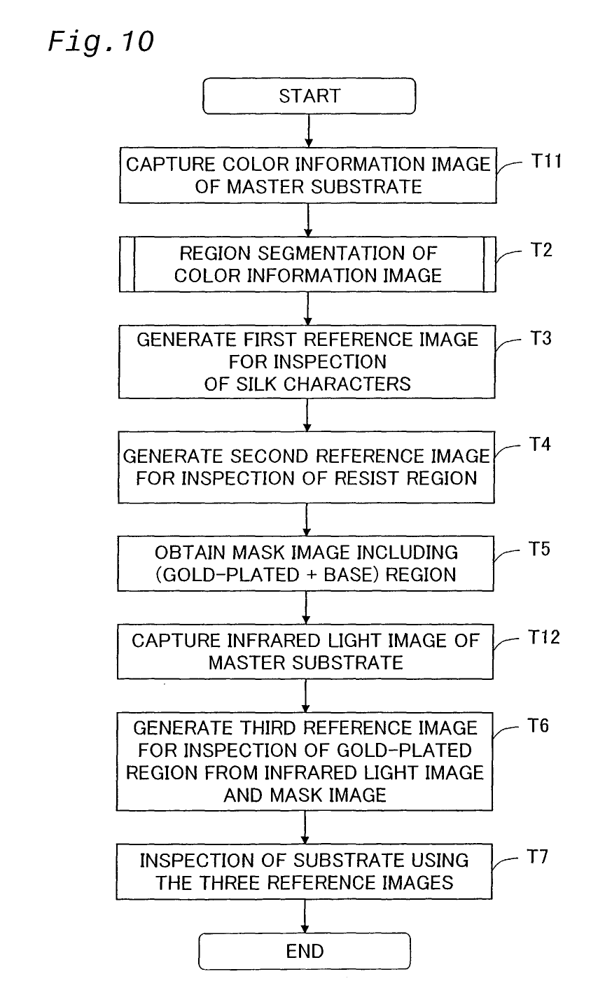

FIG. 10 is a flowchart showing the inspection processing sequence in a fourth embodiment. Any of the first through third embodiments may be employed as the structure of the inspection apparatus.

This procedure is obtained by replacing the initial step T1 of the processing sequence shown in FIG. 3 by a step T11, and inserting a step T12 between step T5 and step T6. In step T11, white light alone is irradiated without irradiating infrared light so as to capture a color image (color information image) of the master substrate. Processing in steps T2 to T5 using this color image is the same as that in the first embodiment (FIG. 3).

Next, in step T12, infrared light alone is irradiated without irradiating white light so as to capture an infrared light image of the master substrate. Subsequent processing is the same as that in the first embodiment (FIG. 3).

When the color information image MG0 and the infrared light image IRM are captured at different times in this manner, the main wavelength bands of the white light and infrared light may be set so as to overlap to some extent. Consequently, a dichroic prism 450 (FIG. 1) or dichroic mirror (FIG. 7) with somewhat inferior wavelength separation performance may be used. It is also possible to omit the dichroic prism 450 and the CCD element 210. This is advantageous in simplifying the structure of the apparatus. On the other hand, in the first and second embodiments, the color information image MG0 and infrared light image IRM can be captured simultaneously, whereby an advantage is gained in that inspection time can be shortened in comparison with the fourth embodiment.

E. Fifth Embodiment

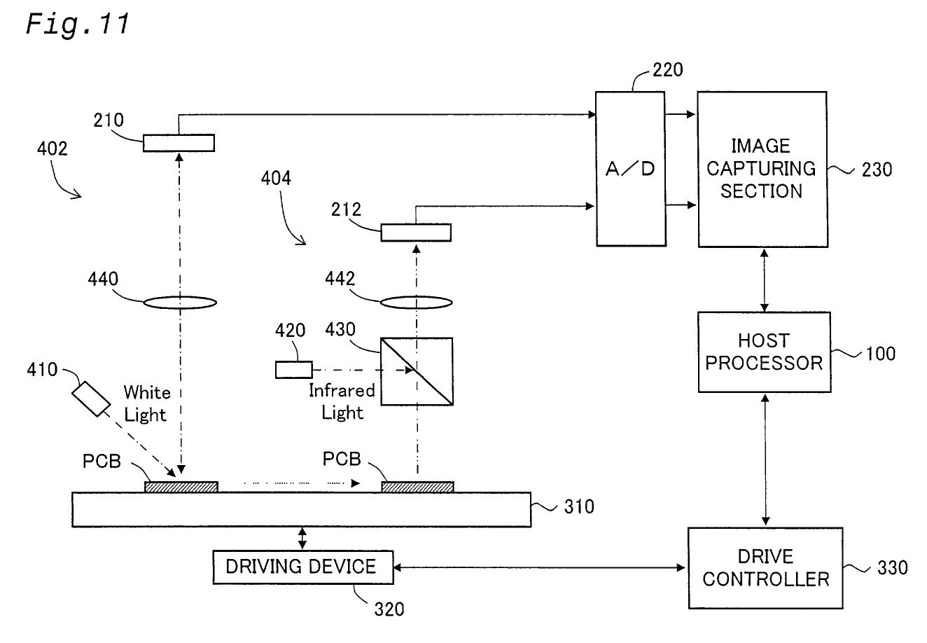

FIG. 11 is a block diagram showing the structure of an inspection apparatus of a fifth embodiment. In this inspection apparatus, the illumination optical system is divided into a first optical system 402 and a second optical system 404. The first optical system 402 is used to capture the color information image MG0. The second optical system 404 is used to capture the infrared light image IRM. The first optical system 402 comprises the white light source 410 and the lens system 440. The white light that is emitted from the white light source 410 is irradiated onto the surface of the printed circuit board PCB from an oblique direction, whereby the resultant reflected light is guided in the normal direction to the first CCD element 210 using the lens system 440. The second optical system 404 comprises the infrared light source 420, the half prism 430, and a lens system 442. The infrared light which is emitted from the infrared light source 420 is reflected by the half prism 430 to illuminate the surface of the printed circuit board PCB substantially perpendicularly. The resultant reflected light is guided to the second CCD element 212 via the half prism 430 and the lens system 442.

During image capturing, first the printed circuit board PCB is positioned under the first optical system 402, whereby the color information image MG0 is captured using the first CCD element 210. Thereafter, the printed circuit board PCB is positioned under the second optical system 404 using the X-Y stage 310, whereby the infrared light image IRM is captured using the second CCD element 212. Note that the same processing sequence as that explained in FIG. 10 may be used.

In the fifth embodiment, an infrared light image for one printed circuit board PCB may be obtained at the same time as a color information image is obtained for the next printed circuit board PCB. Accordingly, throughput which is substantially on a par with that of the first embodiment or second embodiment may be obtained.

In the inspection apparatus of the fifth embodiment, neither the dichroic prism 450 (FIG. 1) nor the dichroic mirror (FIG. 7) are necessary, which is advantageous in that fewer components are needed than in the first embodiment and second embodiment. Also in the fifth embodiment, as in the fourth embodiment, the main wavelength bands in the spectra of the white light and infrared light may be set so as to overlap to a certain extent.

F. Sixth Embodiment

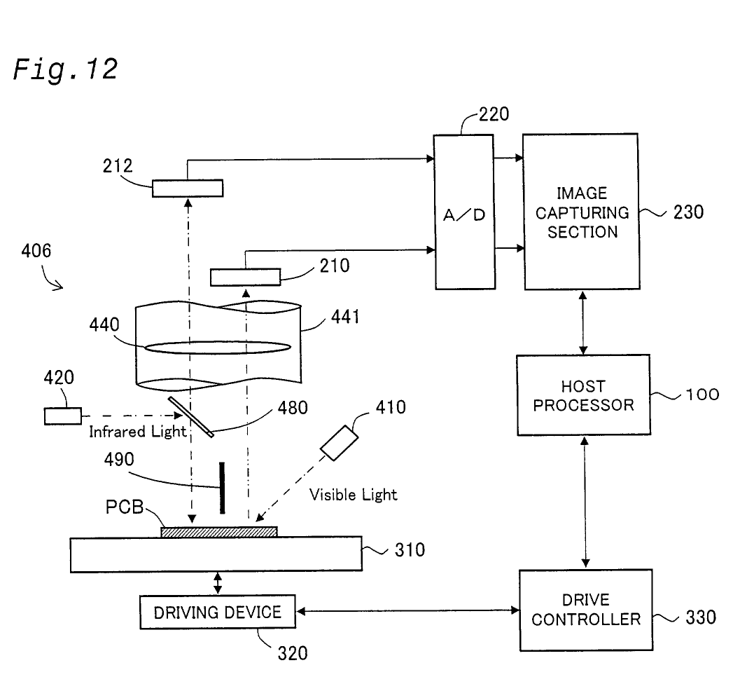

FIG. 12 is a block diagram showing the structure of an inspection apparatus of a sixth embodiment. The optical system 406 of this inspection apparatus comprises a lens system 440 (also referred to as an “imaging optical system”) which is used in common with both infrared light and visible light, and this lens system 440 is accommodated inside a single lens barrel 441. The visible light emitted from the light source 410 is irradiated onto the surface of the printed circuit board PCB from an oblique direction, and the resultant reflected light passes through the lens system 440 in the normal direction such that an image is formed on the first CCD element 210. On the other hand, the infrared light that is emitted from the infrared light source 420 is reflected by a half mirror 480 (or a half prism) and thereby illuminates the surface of the printed circuit board PCB in a substantially perpendicular direction. The resultant reflected light passes through the half mirror 480 and the lens system 440 such that an image is formed on the second CCD element 212. Note that visible light and infrared light are irradiated onto different positions of the printed circuit board PCB. Further, as was explained in the first embodiment, if an identical element is used for the two CCD elements 210, 212, an advantage is gained in that the attachment mechanisms and adjustment methods thereof can be normalized.

This optical system 406 further comprises a light-shielding plate 490 provided in the vicinity of the surface of the printed circuit board PCB. The light shielding plate 490 is provided so that visible light and infrared light do not interfere with each other. Here, the visible light and infrared light “do not interfere with each other” means that effective light does not enter the light path of the other party. If other measures are taken so that visible light and infrared light do not interfere with each other, the light shielding plate 490 may be omitted. For example, if the light spots of the visible light and infrared light on the printed circuit board PCB are sufficiently separated or if the respective pencils of rays thereof are focussed narrowly enough, the light shielding plate 490 may be omitted.

As for the processing sequence, an identical sequence to the first embodiment, shown in FIG. 3, may be employed. In other words, infrared light and visible light are irradiated simultaneously during imaging, and the infrared light image IRM and color information image MG0 are obtained at the same time using the two CCD elements 210, 212. In the sixth embodiment, the principal wavelength bands of the infrared light and visible light are set so as not to overlap, as exemplified in FIG. 6, thereby enabling two images to be obtained simultaneously.

In the inspection apparatus of the sixth embodiment, infrared light and visible light use the same lens system 440 housed inside the same lens barrel 441 in common. Thus, an advantage is gained over the fifth embodiment (FIG. 11) in that a small number of components is sufficient. Note that not all of the lenses of the imaging optical system inside the same lens barrel 441 need to be used in common, and it is adequate if at least one part of the lenses is used in common. However, if all of the lenses in the lens system 440 (imaging optical system) are used in common, an advantage is gained in that the structure thereof becomes simpler.

It is preferable that the convergent angle 2θ of the infrared light that is irradiated substantially perpendicularly onto the printed circuit board PCB be set larger than the convergent angle 2θ of the visible light that is irradiated onto the printed circuit board PCB from an oblique direction, as was explained in the third embodiment (FIGS. 9(a) and 9(b)). It is also possible in this case to construct the optical system 406 such that the infrared light and visible light use all of the lenses in the lens system 440 in common. For example, by adjusting the distances of the two CCD elements 210, 212 from the lens system 440, the light in each of the two CCD elements 210, 212 can be formed into images successfully. Specifically, the distance between the lens system 440 and the infrared light CCD element 210 ought to be made larger than the distance between the lens system 440 and the visible light CCD element 212.

G. Details of Region Segmentation Processing

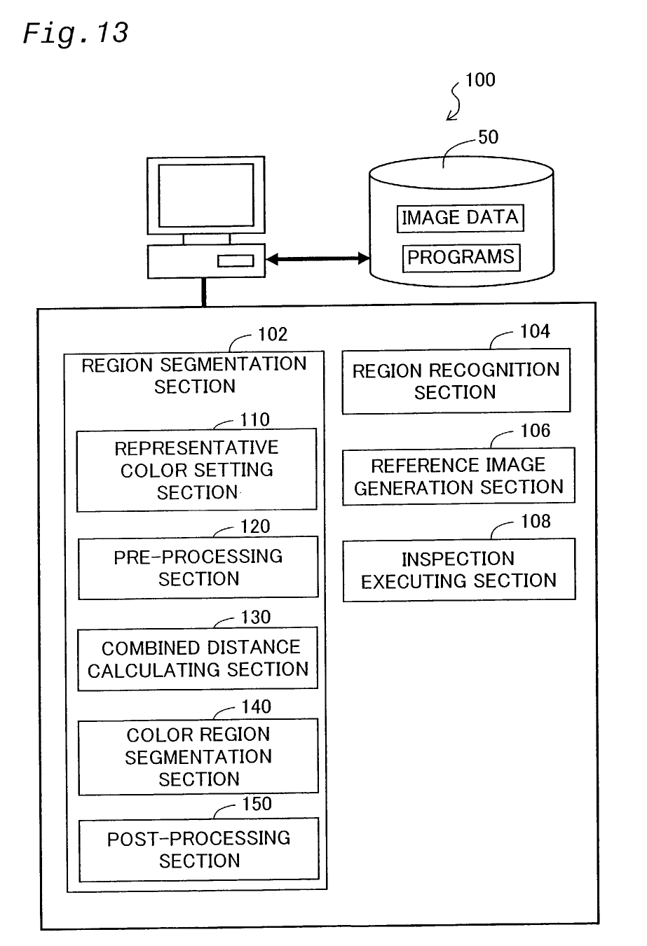

FIG. 13 shows the structure of the host processor 100. The host processor 100 comprises an external storage device 50 for storing various data and computer programs.

The region segmentation section 102 has the functions of a representative color setting section 110, a pre-processing section 120, a combined distance calculating section 130, a color region segmentation section 140, and a post-processing section 150. The host processor 100 executes a computer program stored on the external storage device 50 to implement the functions of these sections. As will be understood from the following description, the combined distance calculating section 130 also functions as an angle index value calculating section and a distance index value calculating section.

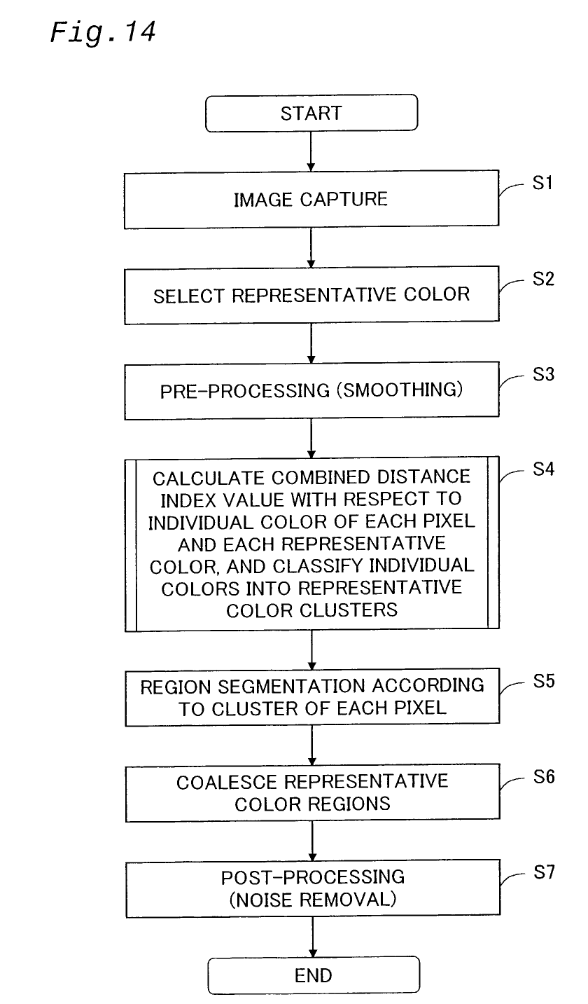

FIG. 14 is a flowchart showing the procedure for region segmentation. In step S1, the region segmentation section 102 obtains a color image of the printed circuit board PCB (FIG. 4) from the image capturing section 230. Note that when processing from step S2 onward is executed for an image captured in advance, image data are read out from the external storage device 50 in step S1.

In step S2, a user sets a plurality of representative colors using a pointing device such as a mouse while observing the color image displayed on the display device of the host processor 100. At this time, the representative color setting section 110 permits the user to set representative colors by displaying a predetermined dialog box for representative color setting processing on the display device of the host processor 100.

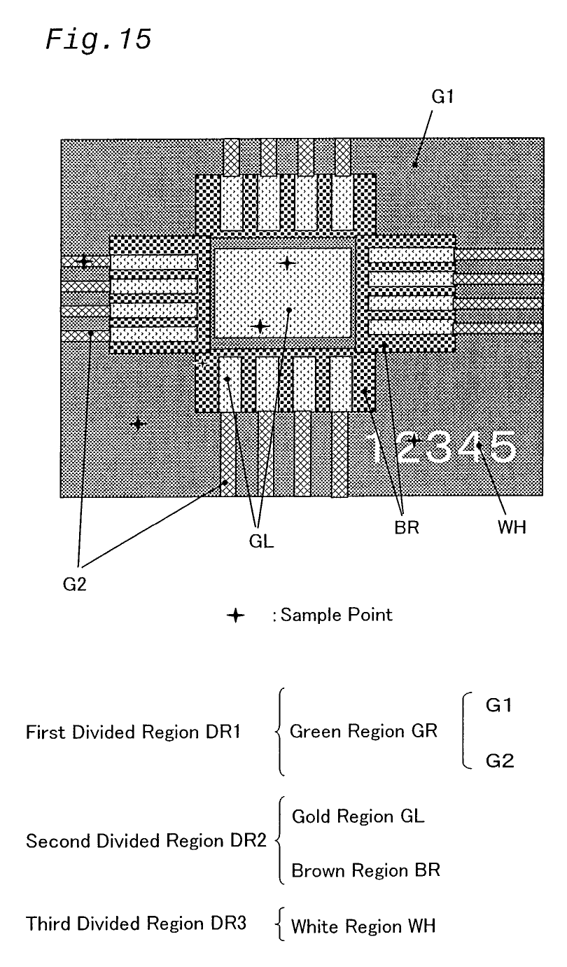

FIG. 15 shows the setting of representative colors. The user inputs the names (for example “resist region”, “gold-plated region” etc.) of the four types of region GR(G1+G2), GL, BR and WH into the dialog box on the screen and also specifies sample points (illustrated by solid stars in FIG. 15) on the color image in order to obtain a representative color for each of the regions. At least one sample point is specified in each of the regions. When a plurality of sample points are specified in the same region, an average color of these sample points is employed as the representative color of that region.

The user also specifies whether or not each of the regions is to be coalesced with another region. In the example in FIG. 15, the green region GR has been specified as constituting a first divided region DR1. The gold region GL and brown region BR have been coalesced and constitute a second divided region DR2, and the white region WH has been specified as constituting a third divided region DR3. The representative color setting section 110 obtains RGB color components of each representative color from the image data of the color image, and then registers the RGB color components of the representative colors of the four regions GR, GL, BR, WH. Note that typically, n (where n is an integer of 2 or more) representative colors are registered.

In step S3 (FIG. 14), the pre-processing section 120 (FIG. 13) executes smoothing processing (graduation processing) on the color image which is subject to processing. In smoothing processing, various smoothing filters may be used, such as a median filter, a Gaussian filter, or a moving average filter. By performing this smoothing processing, anomalous pixel values existing within the image data can be removed, whereby image data with little noise can be obtained. It should be noted that pre-processing may be omitted.

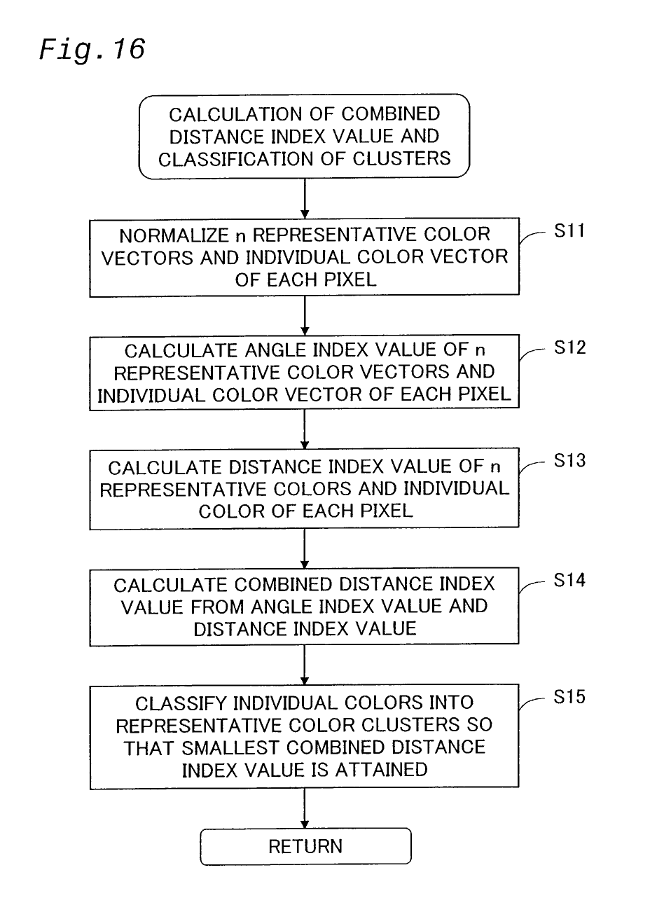

In step S4, the combined distance calculating section 130 calculates the combined distance index values of the plurality of representative colors in relation to the colors (to be referred to as “individual colors”) of each pixel in the color image, and classifies an individual color into a representative color cluster. FIG. 16 is a flowchart showing in detail the procedure of step S4. In step S11, representative color vectors illustrating n (where n is an integer of 2 or greater) representative colors and individual color vectors representing the individual color of each pixel in the color image are normalized. Normalization of the representative color vectors is performed according to the following equations (1a) to (1d).

Lref(i)=Rref(i)+Gref(i)+Bref(i) (1a)

Rvref(i)=Rref(i)/Lref(i) (1b)

Gvref(i)=Gref(i)/Lref(i) (1c)

Bvref(i)=Bref(i)/Lref(i) (1d)

If Lref(i)=0,

Rvref(i)=Gvref(i)=Bvref(i)=⅓

Here, Rref(i) is the R component of the i-th (i=1 to n) representative color, Gref(i) is the G component thereof, and Bref(i) is the B component thereof. Further, Rvref(i), Gvref(i) and Bvref(i) are the RGB components after the normalization. In equation (1a), the value Lref(i) used in normalization is obtained by the arithmetic sum of the three components Rref(i), Gref(i) and Bref(i), and in equations (1b) to (1d) this normalization value Lref(i) is used to normalize each component.

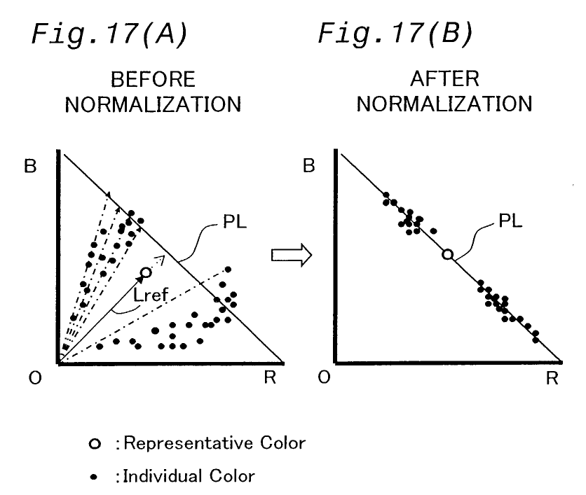

FIGS. 17(A) and 17(B) show the color normalization method according to equations (1a) to (1d). Here, for convenience of illustration, points (white circles) illustrating representative colors and points (black circles) illustrating individual colors are each drawn in a two-dimensional space constituted by two color components, the R component and the B component. The aforementioned equations (1a) to (1d) signify that the representative color vectors are normalized on a plane PL which is defined by R+G+B=1. However, when the representative color is completely black (when Lref(i)=0), the values of each of the components Rvref(i), Gvref(i) and Bvref(i) after normalization are respectively set to ⅓. This is in order to prevent the right side of the equations (1b) to (1d) from becoming infinite.

The individual color vectors of each pixel are also normalized in a similar fashion to the representative colors according to the following equations (2a) to (2d).

L(j)=R(j)+G(j)+B(j) (2a)

Rv(j)=R(j)/L(j) (2b)

Gv(j)=G(j)/L(j) (2c)

Bv(j)=B(j)/L(j) (2d)

If L(j)=0,

Rv(j)=Gv(j)=Bv(j)=⅓

Here, j is a number for identifying each pixel within the color image.

In FIG. 17(B), it appears that the individual colors are dispersed along the periphery of the plane PL even after normalization. However, this is because the figure is a 3-dimensional space seen 2-dimensionally, and in actuality, the individual colors following normalization also all exist on the plane PL.

In step S12 in FIG. 16, an angle index value V(i,j) of the n representative color vectors and the vectors of the individual color of each pixel is calculated according to equation (3a) or equation (3b).

$$\begin{matrix}V ( i , j ) = k1 * \{ \vert Rvref ( i ) - Rv ( j ) \vert + \vert Gvref ( i ) - Gv ( j ) \vert + \vert Bvref ( i ) - Bv ( j ) \vert \} & \text{(3a)} \\ V ( i , j ) = k1 * [ {\{ Rvref ( i ) - Rv ( j ) \}}^{2} + {\{ Gvref ( i ) - Gv ( j ) \}}^{2} + {\{ Bvref ( i ) - Bv ( j ) \}}^{2} ] & \text{(3b)}\end{matrix}$$

The first term inside the parentheses on the right side of equation (3a) is the absolute value of a difference between the R component Rvref(i) following normalization of the i-th representative color and the R component Rv(j) following normalization of the individual color of the j-th pixel. The second and third terms are corresponding values for the G component and the B component. The symbol k1 denotes a predetermined non-zero coefficient. Accordingly, the right side of the equation (3a) has a strong correlation with the distance between the representative colors following normalization and the individual colors following normalization on the plane PL. Equation (3b) uses the square of the difference instead of the absolute value of the difference, and thereby provides the distance between the representative colors following normalization and individual colors following normalization itself. Generally, the angle between the representative color vectors and individual color vectors tends to grow smaller as the distance between the representative colors and individual colors on the plane PL grows smaller. The value V (i,j) obtained by equation (3a) or (3b) is a value which is determined in accordance with the distance between the representative colors and individual colors on the plane PL, and has a strong correlation to the angle between the representative color vectors and individual color vectors. Thus, in this embodiment, the value V(i,j) obtained by equation (3a) or equation (3b) is used as an angle index value which substantially represents the angle between the representative color vectors and individual color vectors.

As can be understood from equations (3a), (3b), other angle index values obtained by equations other than equations (3a), (3b) may be used instead. as far as the angle index value substantially represents the angle between the representative color vectors and individual color vectors within the color space.

Note that when the coefficient k1 is 1, the angle index value V(i,j) takes a value in the range of 0 to 2. This angle index value V(i,j) is calculated for all combinations of the individual color vector of each pixel and the n representative color vectors.

In step S13, a distance index value D(i,j) between the n representative color vectors and the individual color vector of each pixel is calculated according to the following equation (4a) or equation (4b).

$$\begin{matrix}D ( i , j ) = \frac{\vert Rref ( i ) - R ( j ) \vert + \vert Gref ( i ) - G ( j ) \vert + \vert Bref ( i ) - B ( j ) \vert}{k2} & \text{(4a)} \\ D ( i , j ) = \frac{\sqrt{{\{ Rref ( i ) - R ( j ) \}}^{2} + {\{ Gref ( i ) - G ( j ) \}}^{2} + {\{ Bref ( i ) - B ( j ) \}}^{2}}}{k2} & \text{(4b)}\end{matrix}$$

The first term in the parentheses on the right side of equation (4a) is the absolute value of a difference between the R component Rref(i) before normalization of the i-th representative color and the R component R(j) before normalization of the individual color of the j-th pixel. The second and third terms are the corresponding values of the G component and the B component. Further, k2 is a predetermined non-zero coefficient. Equation (4b) uses the square root of the sum of squares of the difference instead of the absolute value of the difference. In equations (4a), (4b), unlike in the aforementioned equations (3a), (3b), non-normalized values Rref(i), R(j) are used. Accordingly, the right-hand side of equations (4a), (4b) give values corresponding to the distance between the non-normalized representative colors and individual colors. Thus, in this embodiment, the value D(i,j) obtained by equation (4a) or equation (4b) is used as a distance index value which substantially represents the distance between the representative colors and individual colors.

As can be understood from equations (4a), (4b), other distance index values obtained by equations other than equations (4a), (4b) may be used instead as far as the distance index value substantially represents the distance between the representative colors and individual colors within the color space, and

When each color component is 8-bit data and the coefficient k2 is 1, the distance index value D(i,j) takes a value in the range of 0 to 765. This distance index value D(i,j) is also calculated for all combinations of the individual color vector of each pixel and the n representative color vectors.

In step S14, a combined distance index value C(i,j) is calculated for the i-th representative color and the individual color of the j-th pixel according to the following equations (5a) or (5b).

$$\begin{matrix}C ( i , j ) = V ( i , j ) + D ( i , j ) & \text{(5a)} \\ C ( i , j ) = V ( i , j ) * D ( i , j ) & \text{(5b)}\end{matrix}$$

In equation (5a), the sum of the angle index value V(i,j) and the distance index value D(i,j) is employed as the combined distance index value C(i,j). In equation (5b), on the other hand, the product of the angle index value V(i,j) and the distance index value D(i,j) is employed as the combined distance index value C(i,j). Accordingly, the combined distance index value C(i,j) obtained in equation (5a) or equation (5b) is a value which becomes smaller as the angle between the individual color vector of the j-th pixel and the i-th representative color vector becomes smaller and as the distance between the individual colors and representative colors in the color space becomes smaller.

When the combined distance index value C(i,j) with respect to each of a plurality of representative colors is calculated for the color of each pixel in this manner, in step S15 the individual color of each pixel is classified into the cluster of the representative color for which the combined distance index value C(i,j) is smallest. Here, “cluster” denotes a gathering of colors associated with one representative color. Since n combined distance index values C(i,j) corresponding to n representative colors are obtained for each pixel, the individual color of each pixel is classified into the representative color cluster having the smallest value from among these n combined distance index values C(i,j).

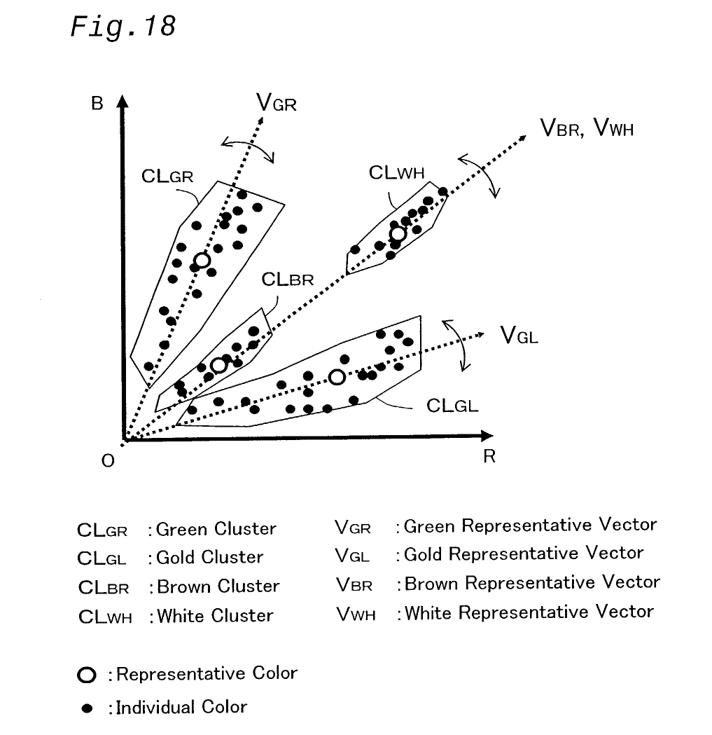

FIG. 18 shows the distribution of individual colors classified into 4 representative color clusters. As was explained in FIG. 15, 4 representative colors are set in step S2 (FIG. 14) corresponding to 4 color regions: the green region GR, gold region GL, brown region BR, and white region WH. Thus, in FIG. 18, the individual color of each pixel is classified into one of the representative color clusters CL_{GR}, CL_{GL}, CL_{BR}, CL_{WH} corresponding to the 4 representative colors. Here, the distance between the comparatively dark colors (colors near the point of origin O on a 3-dimensional color space) from among the individual colors within the gold cluster CL_{GL} and the comparatively dark colors within the brown cluster CL_{BR} is small. In this embodiment, however, the aforementioned combined distance index value C(i,j) is used upon individual color classification, and therefore the individual color of each pixel is classified into a representative color cluster such that the distance between the individual color and the representative color is small and the angle between the vectors thereof is small. Accordingly, inappropriate clustering is prevented, and appropriate clustering is achieved.

When the individual color of each pixel is classified into one of the representative color clusters in this manner, in step S5 in FIG. 14 the color region segmentation section 140 divides the image regions according to the representative color cluster to which the individual colors belong. For example, the image regions are divided by allocating to the pixels belonging to each cluster a unique number (representative color number) which is different from that of the other clusters. Specifically, pixel values 0, 1, 2, 3 are respectively allocated to clusters CL_{GR}, CL_{GL}, CL_{BR}, and CL_{WH} of FIG. 18, for example. Note that regions to which identical representative color numbers have been allocated in step S5 will be referred to as “representative color regions”.

In step S6, the color region segmentation section 140 coalesces representative color regions according to necessity. In this embodiment, as was explained in FIG. 15, the gold region GL and the brown region BR are specified as regions to be coalesced in step S2. Accordingly, in step S5, these regions GL, BR are coalesced into the second divided region DR2.

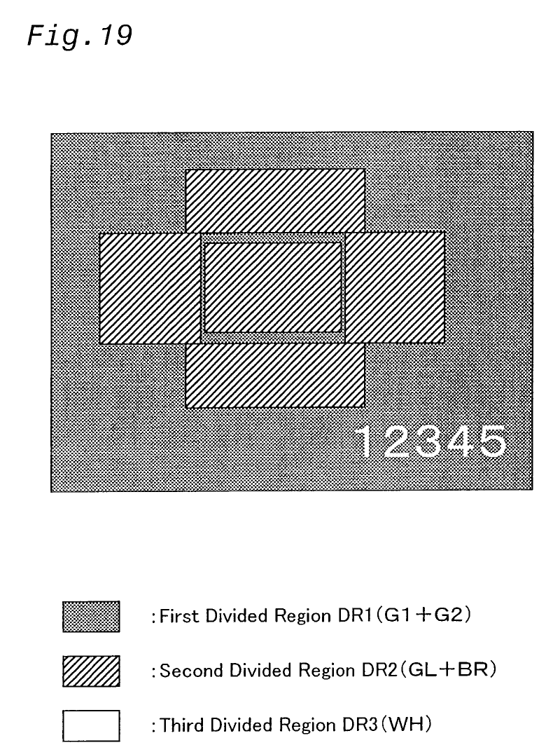

FIG. 19 shows the divided regions following coalescence displayed on the display device of the host processor 100. The first through third divided regions DR1 through DR3 are displayed such that each has a different color or pattern in accordance with the representative color number. The relationship between each representative color number and the color which is painted onto each divided region upon display (display color) is preset by the user. Alternatively, the relationship between each representative color number and the display color may be determined automatically by the color region segmentation section 140. As can be understood from this example, in this embodiment the color image is initially classified into a plurality of representative color regions, whereupon several representative color regions are coalesced according to necessity. When such processing is used, an advantage is gained in that a plurality of regions with different colors may be combined into a single divided region in accordance with the wishes of the user.

When the image regions of the color image are classified into a plurality of divided regions or segmented regions in this manner, in step S7 in FIG. 14 the post-processing section 150 executes post-processing. This post-processing is noise-removal processing including contraction processing and expansion processing. This noise removal processing executes contraction processing by a predetermined pixel width and then executes expansion processing by the same pixel width for the pixels subject to processing in a specific divided region. Similar contraction processing and expansion processing may also be executed for other divided regions. By performing this type of post-processing, minute pinhole regions or noise regions are removed.

As described above, the combined distance index value C(i,j) is calculated on the basis of a distance index value which substantially represents the distance between the individual color of each pixel and a representative color and an angle index value which substantially represents the angle between the individual color vectors and representative color vectors, and the individual color of each pixel is classified into the representative color region such that this value C(i,j) is smallest. Accordingly, it is possible to classify pixel colors which, despite being of the same color originally, have widely differing levels of brightness into the same representative color region. As a result, region segmentation is performed more appropriately than conventional technique.

Note that the aforementioned region segmentation processing is merely an example, and that other types of region segmentation processing may be employed instead.

H. Seventh Embodiment

H-1. Apparatus Structure

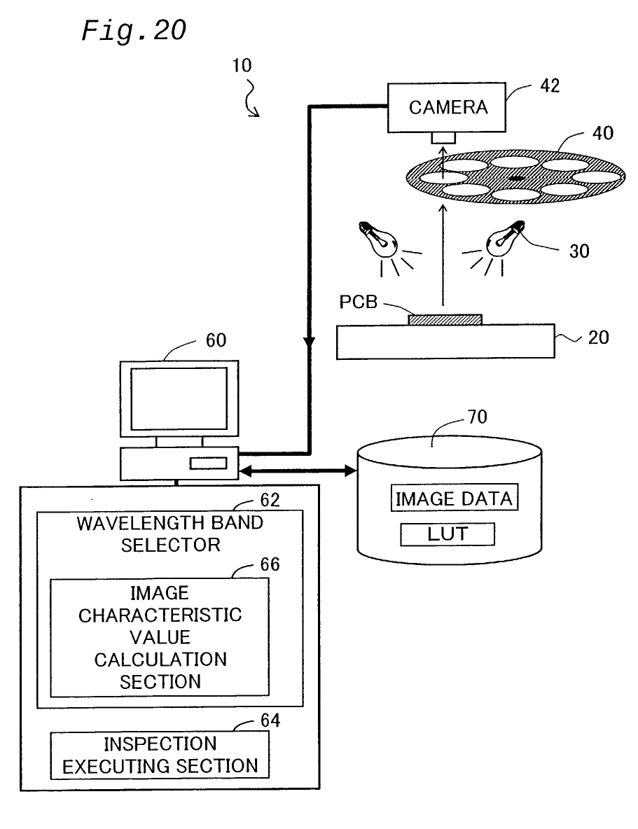

FIG. 20 shows the structure of the inspection apparatus 10 according to a seventh embodiment of the present invention. This inspection apparatus 10 comprises an inspection stage 20 on which the printed circuit board PCB is placed, a white light source 30 for illuminating the printed circuit board PCB, a color filter plate 40 having a plurality of color filters, a camera 42, and a computer 60 for performing control of the entire apparatus. An external storage device 70 for storing image data and computer programs is connected to the computer 60.

The computer 60 has the functions of a wavelength band selector 62 and an inspection execution section 64. The wavelength band selector 62 includes an image characteristic value calculation section 66. The functions of each of these sections 62, 64, 66 are implemented through the execution by the computer 60 of computer programs stored in the external storage device 70.

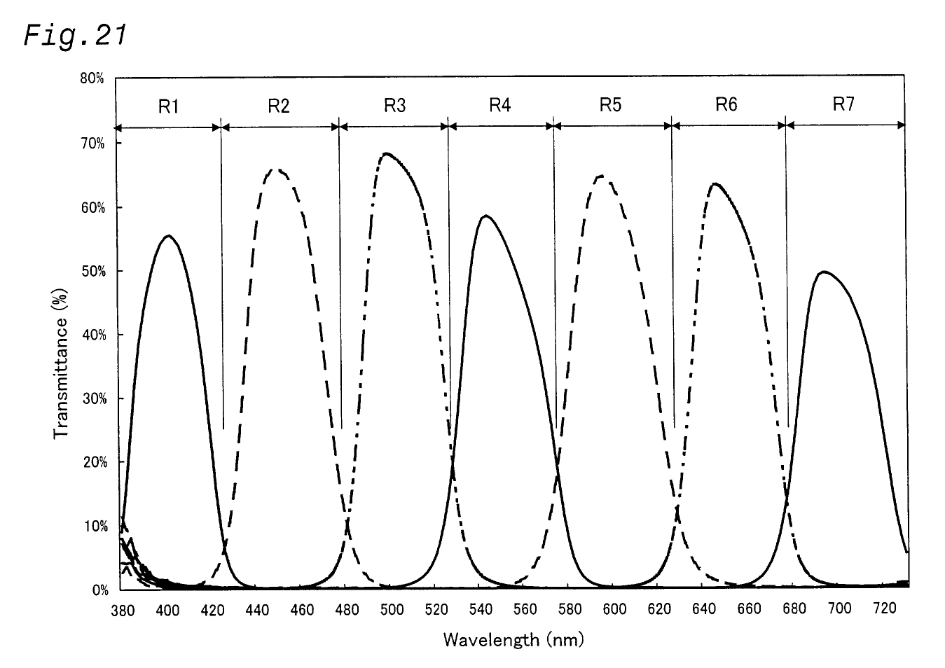

The color filter plate 40 has a plurality of color filters with differing transmission wavelength bands. FIG. 21 is a graph showing the transmittance of the plurality of color filters. Here, the characteristics of 7 color filters, in which 7 wavelength bands R1 to R7 are shown as transmission bands, are displayed. Here, “transmission band” denotes a wavelength range with transmittance of 10% or greater. The transmission bands of the plurality of color filters are different from one another. However, the transmission bands of the color filters may partly overlap to some extent.

The white light emitted from the white light source 30 is reflected on the surface of the printed circuit board PCB, and the resultant reflected light reaches the camera 42 after having passed through one of the 7 color filters. Thus, images relating to the 7 wavelength bands R1 to R7 can be successively obtained using the white light source 30, the color filter plate 40 and the camera 42. In order to obtain these images relating to the 7 wavelength bands R1 to R7, the camera 42 may be a monochrome camera. However the camera 42 may be capable of capturing color images.

H-2. Processing Sequence of the Seventh Embodiment

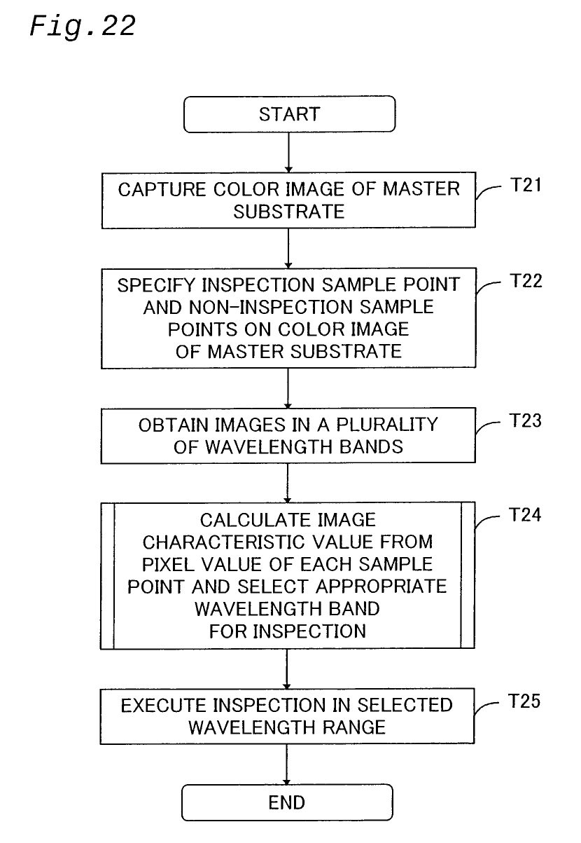

FIG. 22 is a flowchart showing the sequence of inspection processing in the seventh embodiment. In step T21, a master substrate (also referred to as a “reference substrate”) is prepared and, using the inspection apparatus of FIG. 20, a color image of the region on the master substrate which is subject to inspection is captured. Here, “master substrate” denotes a standard printed circuit board used for determining the wavelength band to be used in an inspection. At least one arbitrary printed circuit board selected from a plurality of printed circuit boards of the same type may be used as the master substrate. During the capture of the color image in step T21, white light is used as is without using a color filter.

In the seventh embodiment, the gold region GL is selected from among the various color regions G1, G2, GL, BR, WH on the surface of the printed circuit board PCB shown in FIG. 4 to be subject to inspection. That is, an inspection is conducted as to whether the configuration of the gold region GL is acceptable or not.

In step T22, a color image such as that in FIG. 4 is displayed on the display device of the computer 60, and an operator specifies inspection sample points and non-inspection sample points on this color image. Here, “inspection sample point” indicates a point within the color region which is subject to inspection, whereas “non-inspection sample point” indicates a point inside a color region which is not subject to inspection. In step T24 described later, pixel values are respectively obtained from these sample points. For example, when the gold-plated region is subject to inspection, an inspection sample point is specified inside the gold region GL, and a non-inspection sample point is specified in each of the other color regions (brown region BR, green regions G1 and G2, and white region WH). It is adequate for a sample point to have at least one pixel, but in this embodiment, one sample point includes a plurality of pixels. Accordingly, in this embodiment sample points are also referred to as “sample regions”. Inspection sample points and non-inspection sample points are also simply referred to as “inspection points” and “non-inspection points”.

In step T23, 7 images relating to the 7 wavelength bands R1 to R7 (FIG. 21) are obtained using the 7 color filters. In step T24, the wavelength band selector 62 calculates an image characteristic value in each of the 7 images by a predetermined calculation procedure, and selects a wavelength band which is appropriate for inspection on the basis of this image characteristic value. In this embodiment, the contrast between the inspection sample points and the non-inspection sample points is used as the image characteristic value.

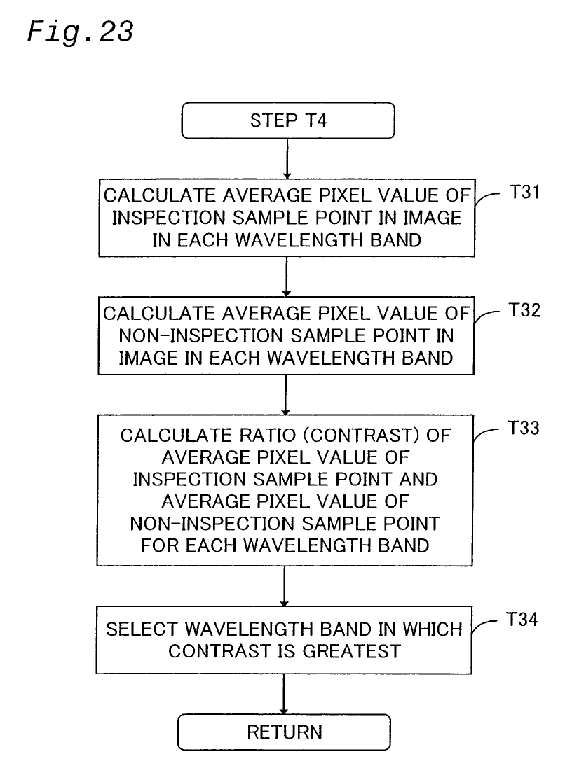

FIG. 23 is a flowchart showing in detail the procedure of step T24 when contrast is employed as the image characteristic value. In step T31, an average pixel value of the inspection sample points is calculated for each wavelength band image. In this embodiment, an inspection sample point is specified in the gold region GL, this inspection sample point includes a plurality of pixels. Further, the wavelength bands are divided into 7. Accordingly, in step T31, an average pixel value relating to the inspection sample point in the gold region GL is calculated for each of the 7 images relating to the 7 wavelength bands.

In step T32, an average pixel value of the non-inspection sample points is calculated for each wavelength band image. An average pixel value relating to the non-subject to inspection point specified in each of the regions G1, G2, BR, WH other than the gold region GL is calculated for each of the 7 images relating to the 7 wavelength bands.

In step S33, the ratio (contrast) of the average pixel value of the inspection sample point and the average pixel values of the non-inspection sample points are calculated for each wavelength band. Then, in step T34, the wavelength with the largest contrast is selected.

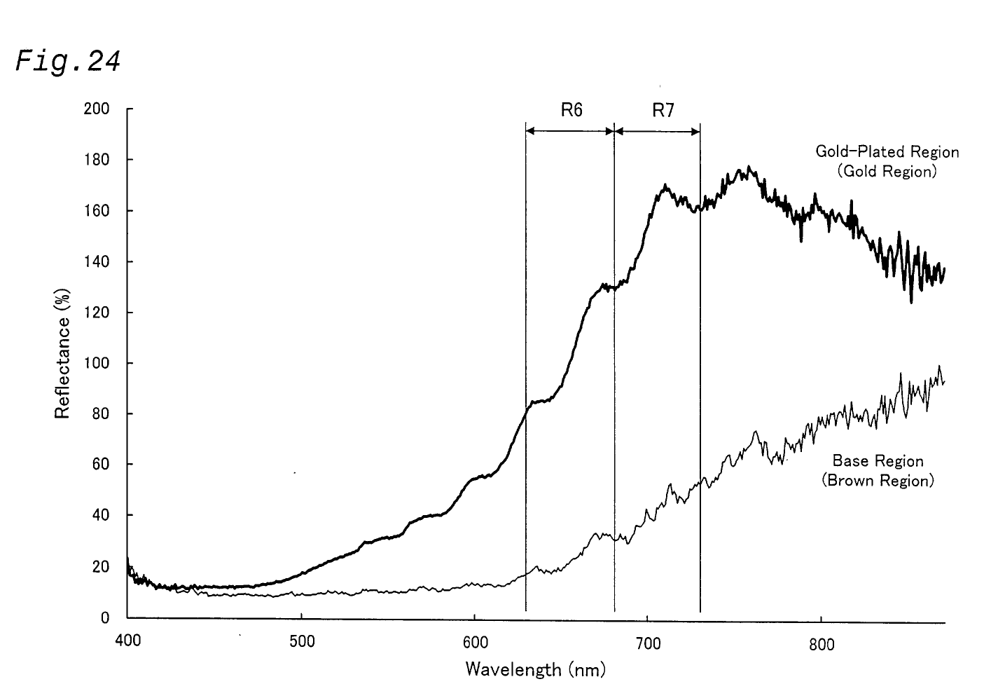

FIG. 24 is a graph showing the spectral reflectance characteristics of the gold region and brown region. The contrast between two regions is generally proportional to the ratio of reflectance thereof. Therefore, the contrast between the gold region GL and the brown region BR is greatest in wavelength band R7, and is smaller in the other wavelength bands. The gold region GL may sometimes appear as a brown region in a normal color image, and therefore the two sometimes cannot be clearly distinguished. However, in the image captured in wavelength band R7, the contrast between the gold region GL and brown region BR is large, and it is therefore possible to distinguish clearly between the gold region GL and the brown region BR.

Although omitted from the drawing, the contrast between the gold region GL and the other color regions G1, G2, WH is also greatest in the wavelength band R7. Thus, in step T34, the wavelength band R7 is selected as the appropriate wavelength band for inspection. As can be understood from this explanation, it is preferable that contrast values be calculated individually for the inspection sample point and non-inspection sample points. In so doing, when the contrast between the inspection sample point and a non-inspection sample point in a specific color region is low in a particular wavelength band, a determination can be made such that this wavelength band is not selected, and a preferable wavelength band can be determined with a high level of precision. It is also possible to select two or more preferable wavelength bands.

When a wavelength band is selected in this manner, in step T25 in FIG. 22 the inspection execution section 64 successively executes inspections of a plurality of printed circuit boards PCB. Specifically, an image of each printed circuit board PCB is captured using a color filter which corresponds to the selected wavelength band R7, whereupon the configuration of the gold region GL (gold-plated section) is examined using these images. In the image captured in wavelength band R7, the contrast between the gold region GL and the other color regions is high, and therefore the gold region GL can be clearly identified from among the other color regions. Accordingly, the inspection of the configuration of the gold region GL can be performed with a high level of precision.

The inspection may be conducted in various ways including: a binary comparison, multi-valued comparison or visual comparison of the master substrate image and the image of each of the substrates subject to inspection, and a comparison of CAD data and the image of each of the substrates subject to inspection.

As described above, at least one appropriate wavelength band for inspection is selected from a plurality of wavelength bands on the basis of a predetermined image characteristic value relating to inspection sample points and non-inspection sample points. During inspection, an image of the printed circuit board PCB is captured using the selected wavelength band. Accordingly, an appropriate wavelength band is selected so that it is suitable for inspection of the materials used on the surface of the printed circuit board PCB. As a result, inspections using image processing can be executed with a high level of precision.

H-3. Other Image Characteristic Values

Values other than the contrast may be used as image characteristic values. The image characteristic value may be a relative value of any values which are calculated at the inspection point and a non-inspection point on the basis of an image of the inspection object. For example, the image sharpness, dispersion of pixel values within the image, standard deviation of the pixel values, and entropy of the pixel values may also be used as the image characteristic value. The entropy of the pixel values may be calculated using the following equation (6), for example.

$$H1 = - {\sum }_{0}^{255} h ( i ) \times ln [ h ( i ) ] \qquad \text{(6)}$$

Here, i is the pixel value (0 to 255) of each pixel constituting the image, and h(i) is a histogram expressing the frequency of the number of pixels at the pixel value of i. The operator ln[ ] denotes a calculation for obtaining a natural logarithm. Note that the histogram h(i) is a normalized value (in other words the probability of occurrence of the pixel value i) such that the integrated value thereof becomes 1. If the image is considered as an information source, the entropy H1 is an index value indicating the amount of information therein. Accordingly, the entropy H1 tends to be become a larger value as the change in the pixel value within the image grows larger. Note that in equation (6), a logarithm log₂[ ] with a radix of 2 may be used instead of the natural logarithm ln[ ].

Also, a fuzzy entropy H2 obtained by the following equations (7a), (7b) may be used instead of the aforementioned entropy H1 .

$$H2 = \frac{1}{M \times N \times ln 2} {\sum }_{0}^{255} Te ( i ) \times h ( i ) \qquad \text{(7a)}$$

Te(i)=−μ(i)×ln[μ(i)]−{1−μ(i)}×ln[1−μ(i)] (7b)

where

$$\begin{matrix}μ ( x ) = 0 & x \leq a \\ μ ( x ) = 2 \frac{x - {a}^{2}}{c - a} & a < x \leq b \\ μ ( x ) = 1 - 2 \frac{x - {a}^{2}}{c - a} & b < x \leq c \\ μ ( x ) = 1 & c \leq x\end{matrix}$$

$$0 \leq a < b < c \leq 255 \text{and} b = \frac{a + c}{2}$$

M×N is the size of the image in number of pixels. Te(i) is a fuzzy member function defining a fuzzy set, the form of which is given in equation (7b). In this embodiment, a=0, b=127.5, and c=255 are used as coefficients a, b, c which define the shape of the fuzzy member function Te(i). This fuzzy entropy H2 also signifies an index value which indicates the amount of information of the image.

When image characteristic values such as image sharpness, dispersion of pixel values inside the image, standard deviation of the pixel values, and entropy of the pixel values are used, the characteristics of the entire captured image becomes subject to evaluation, and hence the specification of sample points becomes unnecessary.

An inspection using characteristics of the entire image may be used when judging the point in time at which surface polishing of a semiconductor wafer is completed. Here, an image of the wafer surface is captured during polishing and the point of completion of the polishing is judged using the characteristics of this image (sharpness, entropy or the like). If provision is made such that a wavelength band is chosen in which the correlation between variation in the image characteristic value and the polishing completion point is at a maximum, the judgment as to the point of completion of the polishing can be made with a high level of precision.

I. Modifications

I1. Modification 1

In the aforementioned first to sixth embodiments, a color image including the three RGB color components is obtained as the color information image. However, it is adequate for the color information image to include at least 2 color components. For example, two of the RGB components may be included in the color information image, or other two color components may be included in the color information image.

I2. Modification 2

In the first to sixth embodiments, white light and infrared light are used as illumination light. However, any two lights with differing principal wavelength bands may be employed instead of white light and infrared light, whereby two types of image relating respectively to these two lights may be obtained. The present invention may be applied in order to identify regions having specific colors on the surface of an object for inspection based on images of these two types of light.

Note, however, that the two types of images preferably include; a color information image which is to be used for performing region segmentation according to color (region extraction); and a contrast image (also referred to as a “multiple tone image”) which is to be used for further separating a specific region recognized by region segmentation into a plurality of regions using the contrast in this specific region. Here, it is preferable that the light which is used to obtain the contrast image has a principal spectrum range in longer wavelengths than that of the light which is used for capturing the color information image. The reason for this is that, as exemplified in FIG. 6, longer wavelength light tends to create a greater contrast in accordance with differences in materials.

I3. Modification 3

In the various aforementioned embodiments, an inspection is performed with a printed circuit board PCB as the object of inspection. However, the present invention may be applied to surface inspections of any object besides a printed circuit board. Note, however, that the present invention is greatly effective in recognizing a plurality of regions on a surface when applied to an inspection of an object in which materials having a metallic sheen are present on the surface, such as a printed circuit board. This effect is particularly striking in an inspection of an object with a gold-plated surface.

I4. Modification 4

In the aforementioned seventh embodiment, an inspection sample point is specified in one color region, but inspection sample points may be respectively specified in a plurality of color regions. In this case, an appropriate wavelength band for inspection is respectively selected for the inspection sample point in each of the color regions.

I5. Modification 5

In the aforementioned seventh embodiment, an appropriate wavelength band for inspection is selected automatically based on an image characteristic value, but instead, the appropriate wavelength band for inspection may be selected by outputting images captured in a plurality of wavelength bands and having a technician compare these images visually. Here, “image output” includes both a case in which the images are displayed on a display device and a case in which the images are formed using a printer. As can be understood from this explanation, it is adequate in the present invention for a wavelength band which is suitable for inspection to be selected from a plurality of wavelength bands on the basis of a plurality of images obtained in relation to light in a plurality of wavelength bands.

I6. Modification 6

In the aforementioned seventh embodiment, images were obtained for 7 wavelength bands R1 to R7. However, the present invention may be applied to an arbitrary number of wavelength bands of 2 or greater. Note, however, that it is preferable for the number of wavelength bands to be set to 3 or more in order that a wavelength band which is appropriate for inspection may be properly selected in accordance with the reflectance and transmittance of the surface of the object for inspection.

I7. Modification 7

In the aforementioned seventh embodiment, images are obtained in relation to visible light in a wavelength band of 400 to 700 nm. However, images may be obtained in relation to light in wavelength bands including ultraviolet light and/or infrared light (of 300 to 900 nm, for example).

I8. Modification 8

In the aforementioned seventh embodiment, a plurality of images relating to a plurality of wavelength bands are obtained using the white light source 30, color filter plate 40 and camera 42. However, the plurality of images relating to the plurality of wavelength bands may be obtained using an imaging device with a different structure. For example, a scanner may be used instead of the camera 42. A multi-band camera or scanner with an in-built color filter may also be used.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An inspection method for inspecting a surface condition of an object for inspection, comprising the steps of:
(a) capturing a first image of a surface of an object while irradiating the surface of the object from an oblique direction with first light, the first image including image components relating to at least two color components included in the first light;
(b) capturing a second image of the surface of the object while irradiating the surface of the object from a substantially perpendicular direction with the second light whose principal spectrum range is in longer wavelengths than the first light; and
(c) identifying a specific color region having a specific color on the surface of the object on the basis of the first image and the second image.

2. An inspection method according to claim 1, wherein the step (c) comprises the steps of:
identifying an integrated color region which includes the specific color region and another color region having a color which is close to the specific color; and
identifying the specific color region from the integrated color region using a tone value of the second image,
wherein spectrum of the second light is set such that a contrast between the specific color region and the other color region is larger in the second image than in the first image.

3. An inspection method according to claim 1, wherein the object for inspection is a printed circuit board for an electronic circuit;
the specific color region is a gold-plated region; and
the second light is infrared light.

4. An inspection method according to claim 1, wherein image capturing is executed simultaneously in the step (a) and the step (b), and
the first light is white light and the second light is infrared light.

5. An inspection method according to claim 1, wherein image capturing is executed at different points in time in the step (a) and the step (b).

6. An inspection method according to claim 1, wherein the second light is converged light which converges into a small light spot on the surface of the object.

7. An inspection method according to claim 1, wherein image capturing is executed simultaneously in the step (a) and the step (b),
the first light is visible light and the second light is infrared light, a principal wavelength band of which does not overlap that of the visible light, and
the visible light and the infrared light reflected from the object pass in common through at least one lens inside a same lens barrel to be respectively formed into images.

8. An inspection method according to claim 7, wherein the infrared light is converged light which converges into a small light spot on the surface of the object, and a convergent angle of the infrared light is set to be larger than a convergent angle of the visible light.

9. An inspection apparatus for inspecting a surface condition of an object for inspection, comprising:
an illumination optical system which includes a first light source for irradiating a surface of an object from an oblique direction with first light, and a second light source for irradiating the surface of the object from a substantially perpendicular direction with second light whose principal spectrum range is in longer wavelengths than the first light;
an imaging device for capturing a first image including image components relating to at least two color components included in the first light and for capturing a second image relating to the second light; and
a region identifying section for identifying a specific color region having a specific color on the surface of the object on the basis of the first image and the second image.

10. An inspection apparatus according to claim 9, wherein the region identifying section comprises the functions of:
identifying an integrated color region which includes the specific color region and another color region having a color which is close to the specific color; and
identifying the specific color region from the integrated color region using a tone value of the second image,
wherein spectrum of the second light is set such that a contrast between the specific color region and the other color region is larger in the second image than in the first image.

11. An inspection apparatus according to claim 9, wherein the object is a printed circuit board for an electronic circuit;
the specific color region is a gold-plated region; and
the second light is infrared light.

12. An inspection apparatus according to claim 9, wherein the imaging device includes a first imaging device for capturing the first image and a second imaging device for capturing the second image at the same time as image capturing is performed by the first imaging device, and
the first light is visible light and the second light is infrared light.

13. An inspection apparatus according to claim 9, wherein the imaging device executes the capturing of the first image and the capturing of the second image at different points in time using an identical imaging element.

14. An inspection apparatus according to claim 9, wherein the second light is converged light which converges into a small light spot on the surface of the object.

15. An inspection apparatus according to claim 9, wherein the imaging device includes:
an image forming optical system which is housed inside a lens barrel;
a first imaging device for capturing the first image by receiving the first light which has passed through the image forming optical system; and
a second imaging device for capturing the second image at the same time as image capturing is performed by the first imaging device by receiving the second light which has passed through the image forming optical system,
wherein the first light is visible light and the second light is infrared light, a principal wavelength band of which does not overlap that of the visible light, and
the visible light and the infrared light reflected off the object pass in common through at least one lens in the image forming optical system housed inside the lens barrel to be respectively formed into images by the first and second imaging devices.

16. An inspection apparatus according to claim 12, wherein the infrared light is converged light which converges into a small light spot on the surface of the object, and a convergent angle of the infrared light is set to be larger than a convergent angle of the visible light.

17. An inspection apparatus according to claim 9, wherein the illumination optical system comprises a plate-type dichroic mirror for separating light reflected off the surface of the object into the first light and the second light.

18. An inspection apparatus according to claim 9, wherein
the imaging device includes a first imaging element for capturing the first image and a second imaging element for capturing the second image,
the first and second imaging elements being elements having identical characteristics.

19. An inspection method for inspecting in succession a plurality of objects of the same type, comprising the steps of:
(a) capturing a plurality of images relating to a plurality of wavelength bands of light with respect to an inspection region of at least one object from among a plurality of objects;
(b) selecting, on the basis of the plurality of images, at least one wavelength band which is appropriate for an inspection from among the plurality of wavelength bands;
(c) capturing in succession images of each object relating to light in the selected wavelength band; and
(d) executing an inspection of each object on the basis of the image of each object relating to the light in the selected wavelength band.

20. An inspection method according to claim 19, wherein the step (b) comprises the steps of:
calculating a value of a predetermined image characteristic for each of the plurality of images; and
performing selection of the wavelength band on the basis of the image characteristic value.

21. An inspection method according to claim 20, wherein the step (b) further comprises a step of specifying an inspection point and a non-inspection point in the inspection region, and
the image characteristic value is calculated as a relative value between the inspection point and non-inspection point.

22. An inspection method according to claim 21, wherein the image characteristic value is a contrast between the inspection point and the non-inspection point.

23. An inspection method according to claim 19, wherein the step (b) comprises the steps of:
outputting the plurality of images; and
executing selection of the wavelength band on the basis of the displayed plurality of images.

24. An inspection apparatus for inspecting in succession a plurality of objects of the same type, comprising:
an imaging device capable of capturing a plurality of images of an inspection region on each object, the plurality of images being associated with a plurality of wavelength bands of light, respectively;
a wavelength band selector for selecting at least one wavelength band which is suitable for inspection from among the plurality of wavelength bands on the basis of the plurality of captured images of at least one of the objects from among the plurality of objects; and
an inspection executing section for executing an inspection of each object on the basis of the image of each object captured by the imaging device in relation to the light in the selected wavelength band.

25. An inspection apparatus according to claim 24, wherein the wavelength band selector calculates a value of a predetermined image characteristic for each of the plurality of images, and executes selection of the wavelength band on the basis of the image characteristic value.

26. An inspection apparatus according to claim 25, wherein the image characteristic value is a relative value between an inspection point and a non-inspection point which are specified in advance in the inspection region.

27. An inspection apparatus according to claim 26, wherein the image characteristic value is a contrast between the inspection point and the non-inspection point.
